(19) United States
(12) Patent Application Publication
(10) Pub. No.: US 2004/0135744 A1
(43) Pub. Date: Jul. 15, 2004

(54) Virtual showcases

(76) Inventors: Oliver Bimber, Providence, RI (US); L Miguel Encarnacao, Warwick, RI (US)

Correspondence Address: GORDON E NELSON, PATENT ATTORNEY, PC, 57 CENTRAL ST, PO BOX 782, ROWLEY, MA, 01969, US

(21) Appl. No.: 10/344,287

(22) PCT Filed: Aug. 10, 2001
(86) PCT No.: PCT/US01/25186

(51) Int. Cl. G09G 3/00

(52) U.S. Cl. 345/32

(57) ABSTRACT

Tecniques that employ a virtual reality system that includes a projection plane to make virtual showcases. Where a real showcase has glass, the virtual showcase has half-silvered mirrors (402) that reflect the projection plane (403) when the mirror is viewed by a person. The virtual reality system receives input from a tracker (407) that tracks the position of the person's head and produces an object space on the projection plane such that when the object is reflected in the portion of the mirrors that are visible from the person's point of view, the reflection is an image space and appears as the person would expect it to appear from the person's point of view. In producing the object space, the virtual reality system takes into account the user's point of view, the portion of the reflective surface that the person can see from that point of view, and the effect of the position and form the mirror on the reflection of the object space.

### CROSS REFERENCES TO RELATED APPLICATIONS

This patent application claims priority from U.S. Provisional Application No. 60/252,296, O. Bimber, et al., Reflecting graphics in curved mirrors, filed 21 Nov. 2000, from U.S. Provisional Application No. 60/224,676, O. Bimber, et al., Virtual Showcases, filed 11 Aug. 2000, and from PCT patent application PCT/US01/18327, O. Bimber, et al., The extended virtual table: an optical extension for table-like projection systems, filed 6 Jun. 2001 and having a priority date of 6 Jun. 2000. It will further be a continuation-in-part of the U.S. national stage patent application corresponding to PCT/US01/18327, which will itself be a continuation-in-part of the U.S. national stage patent application corresponding to PCT/US99/28930, M. Encarnacao, et al., Tools for interacting with virtual environments, filed 7 Dec. 1999 with a priority date of 22 Apr. 1999 and published 2 Nov. 2000 as WO 00/65461. Both PCT/US99/28930 and PCT/US01/18327 are hereby incorporated by reference in their entirety into the U.S. national stage patent application. The present application contains the discussion of the use of mirrors with virtual tables from PCT/US99/28930 and the discussion of the optical properties of the extended virtual table from PCT/US01/18327. The new material in the present application begins with the section titled Using virtual reality systems and mirrors to build virtual showcases.

### 1 BACKGROUND OF THE INVENTION

1.1 Field of the Invention

The invention relates generally to virtual and augmented environments and more specifically to the application of mirror beam-splitters as optical combiners in combination with projection systems that are used to produce virual environments.

1.2 Background

1.2.1 Description of Related Art

There are a number of display systems in addition to see-through head-mounted devices that employ full or half-silvered mirrors. Reference numbers in the following refer to a list of references found in section 1.2.2.

Pepper's Ghosts Configuration (PGC) [15] is a common theatre illusion from around the turn of the century. The illusion is named after John Henry Pepper—a professor of chemistry at the London Polytechnic Institute. At its simplest, a PGC consists of a large plane of glass that is mounted in front of a stage (usually with a 45° angle towards the audience). Looking through the glass plane, the audience is able to simultaneously see the stage area and, due to the self-reflection property of the glass, a mirrored image of an off-stage area below the glass plane. PGC is still used by entertainment and theme parks, such as the Haunted Mansion at Disney World to present special effects to the audience. Some of those systems reflect large projection screens that display prerecorded 2D videos or still images instead of real off-stage areas. The setup at London's Shakespeare Rose Theatre, for instance, applies a large 45° half-silvered mirror to reflect a rear-projection system that is aligned parallel to the floor. A major limitation of PGCs is that they force the audience to observe the scene from predefined viewing areas, and consequently, the viewers' parallax motion is very restricted. Another limitation is that PGCs make no provision for viewing the scene from different perspectives.

Reach-In Systems (RIS) [7,11,12,16] are desktop configurations that normally consist of an upside-down CRT screen which is reflected by a small horizontal mirror. Nowadays, these systems present stereoscopic 3D graphics to a single user who is able to reach into the presented visual space by directly interacting below the mirror. Thus, occlusion of the displayed graphics by the user's hands or input devices is avoided. Such systems are used to overlay the visual space over the interaction space, whereby the interaction space can contain haptic information rendered by a force-feedback device. While most RIS apply full mirrors [11,16], some utilize half-silvered mirrors to augment the input devices with graphics [7,12] or temporarily exchange the full mirror with a half-silvered one for calibration purposes [16]. Like PGCs, RISs have only one correct perspective.

Real Image Displays (RID) [3,5,8,9,10,13,14,17] are display systems that consist of single or multiple concave mirrors. Two types of images exist in nature: real and virtual. A real image is one in which light rays actually come from the image. In a virtual image, they appear to come from the reflected image—but do not. In case of planar or convex mirrors the virtual image of an object is behind the mirror surface, but light rays do not emanate form there. In contrast, concave mirrors can form reflections in front of the mirror surface where emerging light rays cross—so called “real images”. Several RID are commercially available (e.g. [4]), and are mainly employed by the advertisement or entertainment industry. On the one hand, they can present real objects that are placed inside the system in such a way that the reflection of the object forms a three-dimensional real image floating in front of the mirror. On the other hand, a projection screen (such as a CRT screen, etc.) can be reflected instead—resulting in a free-floating two-dimensional image in front of the mirror optics that is displayed on the screen (some refer to these systems as “pseudo 3D displays” since the free-floating 2D image has an enhanced 3D quality). Usually, a RID is used to display prerecorded video images. A limitation of RIDs is that if a real object is located within the same spatial space as the real image formed by a RED (i.e. in front of the mirror surface), the object occludes the mirror optics and consequently the reflected image. Thus, if virtual objects have to be superimposed over real ones, RID suffer from occlusion problems like those encountered with regular projection screens. Additionally, RIDs are not able to dynamically display different view-ependent perspectives of the presented scene.

Varifocal Mirror Systems (MS) [6,8,9] apply flexible mirrors. In some systems the mirror optics is set in vibration by a rear-assembled loudspeaker [6]. Other approaches utilize a vacuum source to manually deform the mirror optics on demand to change its focal length [8,9]. Vibrating devices, for instance, are synchronized with the refresh-rate of a display system that is reflected by the mirror. Thus, the spatial appearance of a reflected pixel can be exactly controlled—yielding images of pixels that are displayed approximately at their correct depth (i.e. no stereo-separation is required). Due to the flexibility of VMS, their mirrors can dynamically deform to a concave, planar, or convex shape (generating real or virtual images). VMW systems are, however, not suitable for optical see-through tasks, since the space behind the mirrors is occupied by the deformation hardware (i.e. loudspeakers or vacuum pumps). In addition, concavely-shaped VMS face the same problems as RID. Therefore, only full mirrors are applied in combination with such systems.

For any system that reflects projection screens in real mirrors, a transformation of the graphics is required before they are displayed. The transformation ensures that the graphics are not perceived by the viewer as being mirrored or distorted. For systems such as PGC and RIS that constrain viewing to restricted areas and benefit from a static mechanical mirror-screen alignment, the transformation is trivial (e.g. a simple mirror-transformation of the frame-buffer content [7] or of the world-coordinate-axes [11,12,16]). Some approaches combine the mirror transformation with the device-to-world-transformation of the input device by computing a composition map during a calibration procedure and multiplying it by the device coordinates during the application [11]. Other approaches determine the projection of virtual points on the reflected image plane via ray-tracing and then map the projection to the corresponding frame-buffer location by reversing one coordinate component [12,16]. Mirror displays that apply curved mirrors (such as RID and VMS) generally don't pre-distort the graphics before they are displayed. Yet, some systems apply additional optics (such as lenses) to stretch the reflected image [8,9]. However, if a view-dependent rendering is required or if the mirror optics is more complex and does not require a strict mechanical alignment, these transformations become more complicated.

PCT/US99/28930 and PCT/US01/18327 describe several systems that utilize single planar mirrors as optical combiners in combination with rear-projection systems [1,2]. In these systems, scene transformations are disclosed that support non-static mirror-screen alignments and view-dependent rendering for single users. The work disclosed herein extends the techniques used in these systems to multiple planar or curved mirror surfaces and presents real-time rendering methods and image deformation techniques for such surfaces.

1.2.2 References for the Description of Related Art

[1] Bimber, O., Encarnacao, L. M., and Schmalstieg, D. Real Mirrors Reflecting Virtual Worlds. In Proceedings of IEEE Virtual Reality (VR'00), IEEE Computer Society, pp. 21-28, 2000.

[2] Bimber, O., Encarnacao, L. M., and Schinalstieg, D. Augmented Reality with Back-Projection Systems using Transflective Surfaces. Computer and Graphics Forum (Proceedigs of EUROGRAPHICS 2000), vol. 19, no. 3, NCC Blackwell, pp. 161-168, 2000.

[3] Chinnock, C. Holographic 3-D images float in free space. Laser Focus World, vol. 31, no. 6, pp. 22-24, 1995.

[4] Dimensional Media Associates, Iac., URL: http://www.3dmedia.coml, 2000.

[5] Elings, V. B. and Landry, C. J. Optical display device. U.S. Pat. No. 3,647,284, 1972.

[6] Fuchs, H., Pizer, S. M., Tsai, L. C., and Bloombreg, S. H. Adding a True 3-D Display to a Raster Graphics System. IEEE Computer Graphics and Applications, vol. 2, no. 7, pp. 73-78, IEEE Computer Society, 1982.

[7] Knowlton, K C. Computer Displays Optically Superimpose on Input Devices. Bell Systems Technical Journal, vol. 53, no. 3, pp. 36-383, 1977.

[8] McKay, S., Mason, S., Mair, L. S., Waddell, P., and Fraser, M. Membrane Mirror Based Display For Viewing 2D and 3D Images. In proceedings of SPIE, vol. 3634, pp. 144-155, 1999.

[9] McKay, S., Mason, S., Mair, L. S., Waddell, P., and Fraser, M. Stereoscopic Display using a 1.2-M Diameter Stretchable Membrane Mirror. In proceedings of SPIE, vol. 3639, pp. 122-131, 1999.

[10] Mizuno, G. Display device. U.S. Pat. No. 4,776,118, 1988.

[11] Poston, T. and Serra, L. The Virtual Workbench: Dextrous VR. In Proceedings of Virtual Reality Software and Technology (VRST'94), pp. 111-121, IEEE Computer Society (publ.), 1994.

[12] Schmandt, C. Spatial Input/Display Correspondence in a Stereoscopic Computer Graphics Workstation. Computer Graphics (Proceedings of SIGGRAPH'83), vol. 17, no. 3, pp. 253-261, ACM Press, 1983.

[13] Starkey, D. and Morant, R. B. A technique for making realistic three-dimensional images of objects. Behaviour Research Methods & Instrumentation, vol. 15, no. 4, pp. 420-423, The Psychonomic Society, 1983.

[14] Summer S. K., et. al. Device for the creation of three-dimensional images. U.S. Pat. No. 5,311,357, 1994.

[15] Walker, M. Ghostmasters: A Look Back at America's Midnight Spook Shows. Cool Hand Publ., ISBN 1-56790-146-8, 1994.

[16] Weigand, T. E., von Schloerb, D. W., and Sachtler, W. L. Virtual Workbench: Near-Field Virtual Environment System with Applications. Presence, vol. 8, no. 5, pp. 492-519, MIT Press, 1999.

[17] Welck, S. A. Real image projection system with two curved reflectors of paraboloid of revolution shape having each vertex coincident with the focal point of the other. U.S. Pat. No. 4,802,750, 1989.

### 2 SUMMARY OF THE INVENTION

In one aspect, the invention is apparatus for producing an image space. The apparatus comprises apparatus for producing an object space, a convex reflective surface that has a position relative to the object space such that there is a reflection of the object space in the reflective surface, and a tracker that tracks the position of the head of a person who is looking into the convex reflective surface. The apparatus for producing the object space receives the position information from the tracker, uses the position information to determine the person's field of view in the reflective surface, and producing the object space such that the image space appears in the field of view.

Important features of the above invention are that the image space does not appear to be distorted to the person who is viewing the convex reflective surface and that the reflective surface may be either curved or made up of a number of planar reflective surfaces. The curved surface may be a cone and the planar reflective surfaces may form a pyramid. The object space may be either above or below the reflective surface. When the reflective surfaces are planar, the image space seen in a plurality of the mirrors may be the same, or the image space seen in each mirror may be different. The mirrors may further transmit light as well as reflect it and a real object that is part of the image space may be viewed through the mirrors. The object space may then be used to produce images that augment the real object in the image space. An important use of the apparatus is to make virtual showcases, in which real objects positioned inside the convex reflective surface may be augmented by material produced in the object space.

Other aspects of the invention include a method for producing the object space and compensating for distortion caused by the apparatus for producing the object space and by refraction in the mirrors and a method of transforming an image space to produce a planar image space such that when a reflection of the object space in a curved reflective surface is seen from a given point of view, the reflection contains the image space.

Other objects and advantages will be apparent to those skilled in the arts to which the invention pertains upon perusal of the following Detailed Description and drawing, wherein:

### 3 BRIEF DESCRIPTION OF THE DRAWING

FIG. 1: Conceptual sketch and photograph of the xVT prototype

FIG. 2: A large coherent virtual content viewed in the mirror, or on the projection plane

FIG. 3: Real objects behind the mirror are illuminated and augmented with virtual objects.

FIG. 4: The developed Virtual Showcase Prototypes. A Virtual Showcase built from planar sections (right), and a curved Virtual Showcase (left).

FIG. 5: Reflections of individual images rendered within the object space for each front-facing mirror plane merge into a single consistent image space.

FIG. 6: The truncated pyramid-like Virtual Showcase.

FIG. 7: Transformations with curved mirrors.

FIG. 8: Sampled distorted grid and predistorted grid after projection and re-sampling

FIG. 9: Bilinear interpolation within an undistorted/predistorted grid cell.

FIG. 10: Precise refraction method and refraction approximation.

FIG. 11: Overview of rendering (no fill) and image deformation (gray fill) steps, expressed as pipeline.

FIG. 12: Example of steps 1102, 1104, and 1106 of FIG. 11

FIG. 13: Overview of an implementation of the invention in a virtual table;

FIG. 14: Optics of the foil used in the reflective pad;

FIG. 15: The angle of the transparent pad relative to the virtual table surface determines whether it is transparent or reflective;

FIG. 16: The transparent pad can be used in reflective mode to examine a portion of the virtual environment that is otherwise not visible to the user;

FIG. 17: How the portion of the virtual environment that is reflected in a mirror is determined;

FIG. 18: How ray pointing devices may be used with a mirror to manipulate a virtual environment reflected in the mirror;

FIG. 19: Overview of virtual reality system program 109;

FIG. 20: A portion of the technique used to determine whether the pad is operating in transparent or reflective mode;

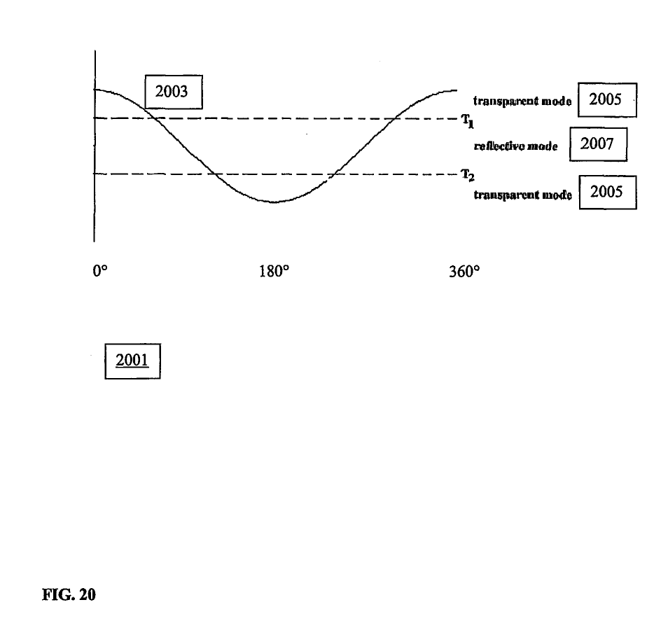

FIG. 21: A transflective panel may be used with a virtual environment to produce reflections of virtual objects that appear to belong to a physical space;

FIG. 22: How the transflective panel may be used to prevent a virtual object from being occluded by a physical object; and

FIG. 23: How the transflective panel may be used to augment a physical object with a virtual object.

FIG. 24: The truncated cone-like Virtual Showcase.

FIG. 25: Compensating for projection distortion.

FIG. 26: Compensating for refraction.

FIG. 27: Virtual Showcase configuration: up-side-down.

FIG. 28: Virtual Showcase configuration: individual screens.

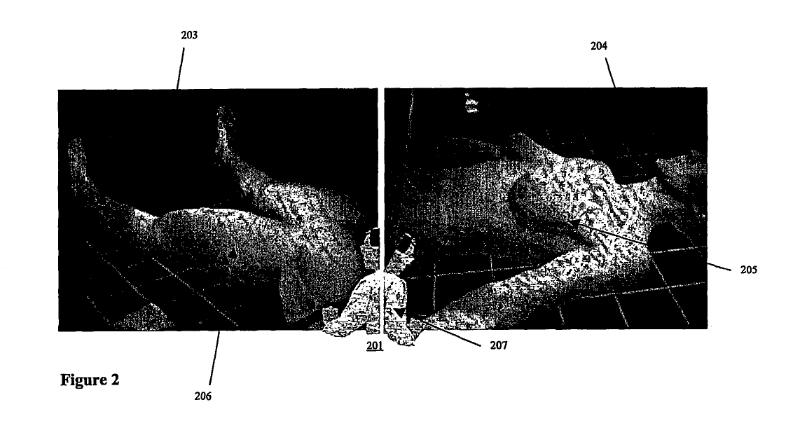

Reference numbers in the drawing have three or more digits: the two right-hand digits are reference numbers in the drawing indicated by the remaining digits. Thus, an item with the reference number 203 first appears as item 203 in FIG. 2.

### 4. DETAILED DESCRIPTION

The following description begins with the relevant disclosure from PCT/US99/28930 and PCT/US01/18327 and will then describe how techniques described in these patent applications can be further developed and used together with new techniques to build a new augmented reality display device which we term the Virtual Showcase. The discussion of the Virtual Showcase begins with the section titled Using virtual reality systems and mirrors to build virtual showcases.

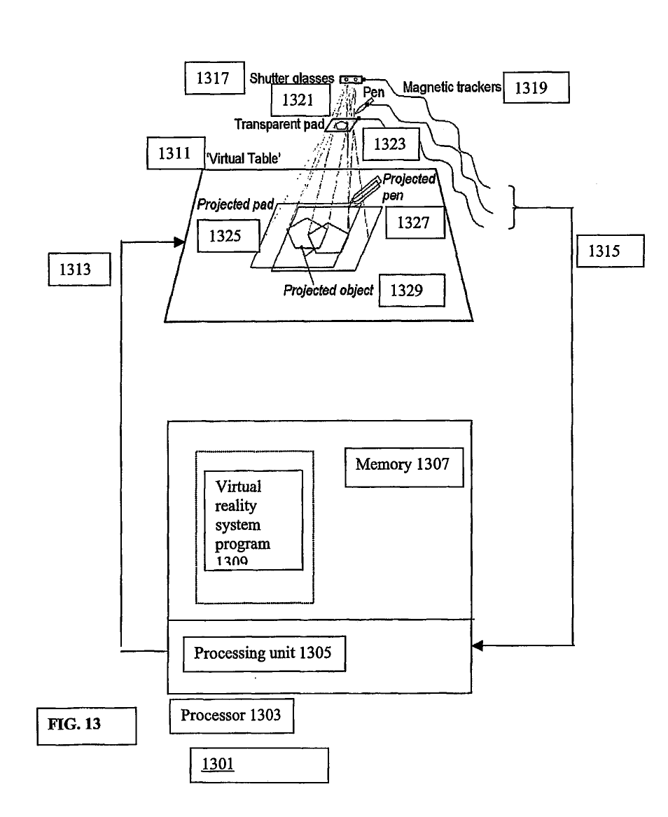

Overview of a Virtual Table: FIG. 13

The virtual environment used in a virtual showcase may be provided using a system of the type shown in FIG. 13. System 1301 for creating a virtual environment on a virtual table 1311. Processor 1303 is executing a virtual reality system program 1309 that creates stereoscopic images of a virtual environment. The stereoscopic images are back-projected onto virtual table 1311. As is typical of such systems, a user of virtual table 1311 views the images through LCD shutter glasses 1317. When so viewed, the images appear to the user as a three-dimensional virtual environment. Shutter glasses 1321 have a magnetic tracker attached to them which tracks the position and orientation of the shutter glasses, and by that means, the position and orientation of the user's eyes. Any other kind of 6DOF tracker could be used as well. The position and orientation are input (1315) to processing unit 1305 and virtual reality system program 1309 uses the position and orientation information to determine the point of view and viewing direction from which the user is viewing the virtual environment. It then uses the point of view and viewing direction to produce stereoscopic images of the virtual reality that show the virtual reality as it would be seen from the point of view and viewing direction indicated by the position and orientation information.

Details of a Preferred Embodiment of the Virtual Table

Hardware

A preferred embodiment of system 1301 uses the Baron Virtual Table produced by the Barco Group as its display device. This device offers a 53″×40″ display screen built into a table surface. The display is produced by a Indigo2™ Maximum Impact workstation manufactured by Silicon Graphics, Incorporated. When the display is viewed through CrystalEyes® shutter glasses from StereoGraphics Corporation, the result is a virtual environment of very high brightness and contrast. The shutter glasses in the preferred embodiment are equipped with 6DOF (six degrees of freedom) Flock of Birds® trackers made by Ascension Technology Corporation for position and orientation tracking.

Software

Software architecture: In the preferred embodiment, virtual reality system program 1309 is based on the Studierstube software framework described in D. Schmalstieg, A. Fuhbrmann, Z. Szalavdri, M. Gervautz: “Studierstube”—An Environment for Collaboration in Augmented Reality. Extended abstract appeared Proc. of Collaborative Virtual Environments '96, Nottingham, UK, Sep. 19-20, 1996. Full paper in: Virtual Reality—Systems, Development and Applications, Vol. 3, No. 1, pp. 3749, 1998. Studierstube is realized as a collection of C++ classes that extend the Open Inventor toolkit, described at P. Strauss and R. Carey: An Object Oriented 3D Graphics Toolkit. Proceedings of SIGGRAPH'92, (2):341-347, 1992. Open Inventor's rich graphical environment approach allows rapid prototyping of new interaction styles, typically in the form of Open Inventor node kits. Tracker data is delivered to the application via an engine class, which forks a lightweight thread to decouple graphics and I/O. Off-axis stereo rendering on the VT is performed by a special custom viewer class. Studierstube extends Open Inventor's event system to process 3D (i.e., true 6DOF) events, which is necessary for choreographing complex 3D interactions like the ones described in this paper. The .iv file format, which includes our custom classes, allows convenient scripting of most of an application's properties, in particular the scene's geometry. Consequently very little application-specific C++ code—mostly in the form of event callbacks—was necessary.

Calibration. Any system using augmented props requires careful calibration of the trackers to achieve sufficiently precise alignment of real and virtual world, so the user's illusion of augmentation is not destroyed. With the VT this is especially problematic, as it contains metallic parts that interfere with the magnetic field measured by the trackers. To address this problem, we have adopted an approach similar to the one described in M. Agrawala, A. Beers, B. Frohlich, P. Hanrahan, I. McDowall, M. Bolas: The Two-User Responsive Workbench: Support for Collaboration Through Individual Views of a Shared Space. Proceedings of SIGGRAPH, 1997, and in W. Krüger, C. Bohn, B. Frohlich, H. Schüth, W. Strauss, and G. Wesche: The Responsive Workbench: A Virtual Work Environment. IEEE Computer, 28(7):4248, 1995. The space above the table is digitized using the tracker as a probe, with a wooden frame as a reference for correct real-world coordinates. The function represented by the set of samples is then numerically inverted and used at runtime as a look-up table to correct for systematic errors in the measurements.

Window tools: The rendering of window tools generally follows the method proposed in J. Viega, M. Conway, G. Williams, and R. Pausch: 3D Magic Lenses. In Proceedings of ACM UIST'96, pages 51-58. ACM, 1996, except that it uses hardware stencil planes. After a preparation step, rendering of the world “behind the window” is performed inside the stencil mask created in the previous step, with a clipping plane coincident with the window polygon. Before rendering of the remaining scene proceeds, the window polygon is rendered again, but only the Z-buffer is modified. This step prevents geometric primitives of the remaining scene from protruding into the window. For a more detailed explanation, see D. Schmalstieg, G. Schaufler: Sewing Virtual Worlds Together With SEAMS: A Mechanism to Construct Large Scale Virtual Environments. Technical Report TR-186-2-87-11, Vienna University of Technology, 1998.

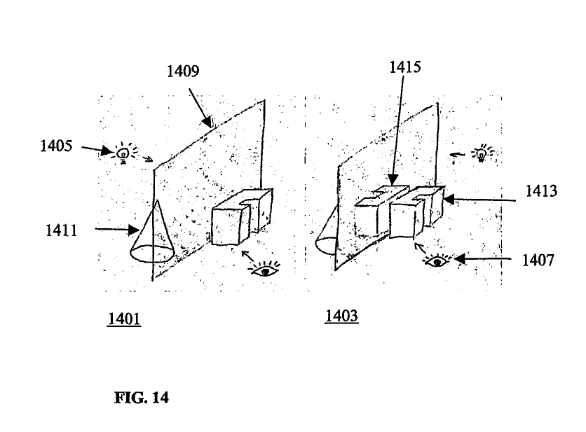

The Mirror Tool: FIGS. 14-16

The mirror tool is a special application of a general technique for using real mirrors to view portions of a virtual environment that would otherwise not be visible to the user from the user's current viewpoint and to permit more than one user to view a portion of a virtual environment simultaneously. The general technique will be explained in detail later on.

When transparent pad 1323 is being used as a mirror tool, it is made reflective instead of transparent. One way of doing this is to use a material which can change from a transparent mode and vice-versa. Another, simpler way is to apply a special foil that is normally utilized as view protection for windows (such as Scotchtint P-18, manufactured by Minnesota Mining and Manufacturing Company) to one side of transparent pad 1323. These foils either reflect or transmit light, depending on which side of the foil the light source is on, as shown in FIG. 14. At 1401 is shown how foil 1409 is transparent when light source 1405 is behind foil 1409 relative to the position 1407 of the viewer's eye, so that the viewer sees object 1411 behind foil 1409. At 1406 is shown how foil 1409 is reflective when light source 1405 is on the same side of foil 1409 relative to position 1407 of the viewer's eye, so that the viewer sees the reflection 1415 of object 1413 in foil 1409, but does not see object 1411.

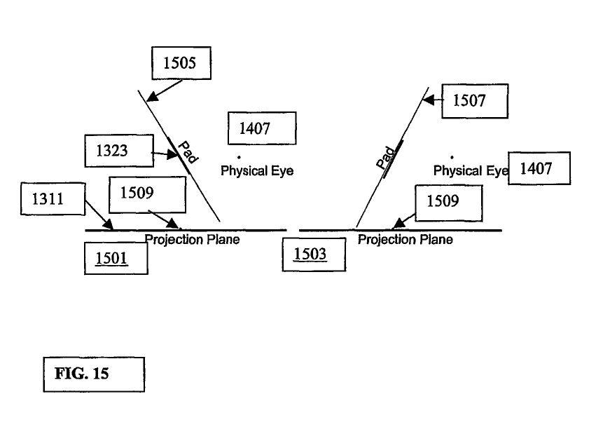

When a transparent pad 1323 with foil 1409 applied to one side is used to view a virtual environment, the light from the virtual environment is the light source. Whether transparent pad 1323 is reflective or transparent depends on the angle at which the user holds transparent pad 1323 relative to the virtual environment. How this works is shown in FIG. 15. The transparent mode is shown at 1501. There, transparent pad 1323 is held at an angle relative to the surface 1311 of the virtual table which defines plane 1505. Light from table surface 1311 which originates to the left of plane 1505 will be transmitted by pad 1323; light which originates to the right of plane 1505 will be reflected by pad 1323. The relationship between plane 1505, the user's physical eye 1407, and surface 1311 of the virtual table (the light source) is such that only light which is transmitted by pad 1323 can reach physical eye 1407; any light reflected by pad 1323 will not reach physical eye 1407. What the user sees through pad 1323 is thus the area of surface 1311 behind pad 1323.

The reflective mode is shown at 1503; here, pad 1323 defines plane 1507. As before, light from surface 1311 which originates to the left of plane 1507 will be transmitted by pad 1323; light which originates to the right of plane 1507 will be reflected. In this case, however, the angle between plane 1507, the user's physical eye 1407, and surface 1311 is such that only light from surface 1311 which is reflected by pad 1323 will reach eye 1407. Further, since pad 1323 is reflecting, physical eye 1407 will not be able to see anything behind pad 1323 in the virtual environment.

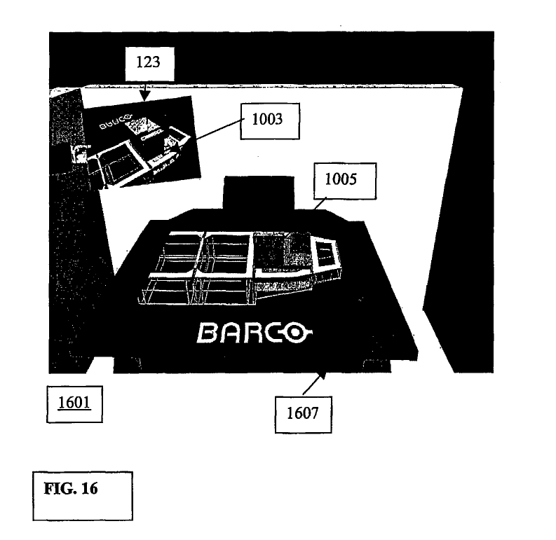

When pad 1323 is held at an angle to surface 1311 such that it reflects the light from the surface, it behaves relative to the virtual environment being produced on surface 1311 in exactly the same way as a mirror behaves relative to a real environment: if a mirror is held in the proper position relative to a real environment, one can look into the mirror to see things that are not otherwise visible from one's present point of view. This behavior 1601 relative to the virtual environment is shown in FIG. 16. Here, virtual table 1607 is displaying a virtual environment 1605 showing the framing of a self-propelled barge. Pad 1323 is held at an angle such that it operates as a mirror and at a position such that what it would reflect in a real environment would be the back side of the barge shown in virtual environment 1605. As shown at 1603, what the user sees reflected by pad 1323 is the back side of the barge.

In order to achieve the above behavior 1601, virtual reality system program 1309 tracks the position and orientation of pad 1323 and the position and orientation of shutter glasses 1317. When those positions and orientations indicate that the user is looking at pad 1323 and is holding pad 1323 at an angle relative to table surface 1311 and user eye position 1407 such that pad 1323 is behaving as a mirror, virtual reality system program 1309 determines which portion of table surface 1311 is being reflected by pad 1323 to user eye position 1407 and what part of the virtual environment would be reflected by pad 1323 if the environment was real and displays that part of the virtual environment on the portion of table surface 1311 being reflected by pad 1323. Details of how that is done will be explained later.

Of course, since what is being reflected by pad 1323 is actually being generated by virtual reality system program 1309, what is reflected may not be what would be seen in a real environment. For example, what is reflected in the mirror might be a virtual environment that shows the inside of the object being viewed with the mirror, while the rest of the virtual environment shows its outside. In this regard, pad 1323 can function in both reflective and transparent modes as a magic lens, or looked at somewhat differently, as a hand-held clipping plane that defines an area of the virtual environment which is viewed in a fashion that is different from the manner in which the rest of the virtual environment is viewed.

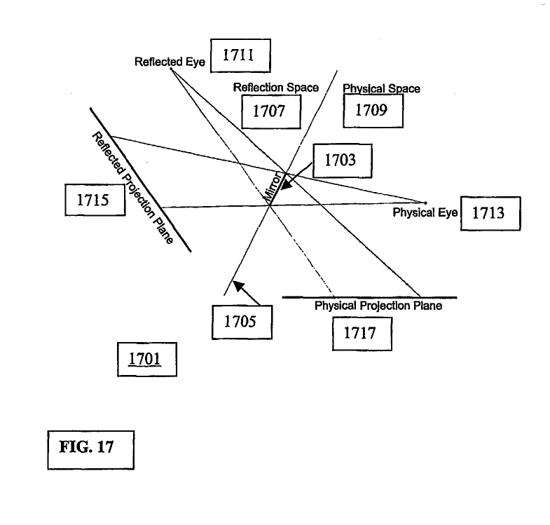

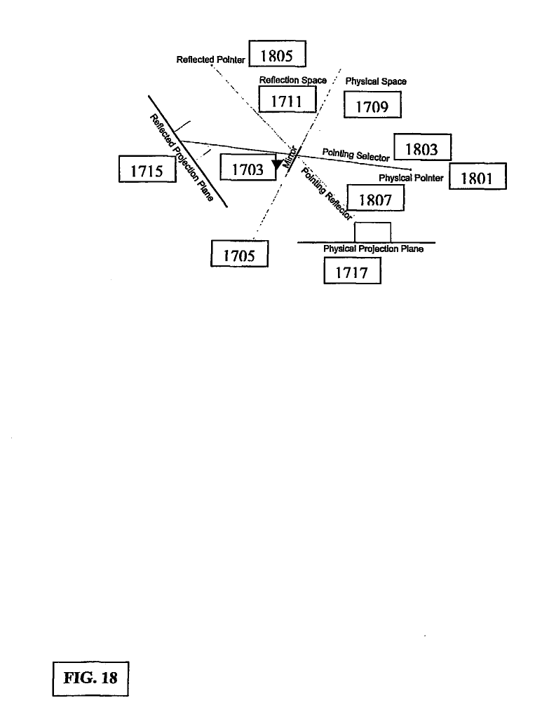

Using Real Mirrors to Reflect Virtual Environments: FIGS. 17 and 18

As indicated in the discussion of the mirror tool above, the mirror tool is a special application of a general technique for using mirrors to view virtual environments. Head tracking, as achieved for example in the preferred embodiment of system 1301 by attaching a magnetic tracker to shutter glasses 1317, represents one of the most common, and most intuitive methods for navigating within immersive or semi-immersive virtual environments. Back-screen-projection planes are widely employed in industry and the R&D community in the form of virtual tables or responsive workbenches, virtual walls or powerwalls, or even surround-screen projection systems or CAVEs. Applying head-tracking while working with such devices can, however, lead to an unnatural clipping of objects at the edges of projection plane 1311. Such clipping destroys the sense of immersion into the virtual scene and is in consequence a fundamental problem of these environments. Standard techniques for overcoming this problem include panning and scaling techniques (triggered by pinch gestures) that reduce the projected scene to a manageable size. However, these techniques do not work well when the viewpoint of the user of the virtual environment is continually changing.

To address these problems we have developed a navigation method called mirror tracking that is complementary to single-user head tracking. The method employs a planar mirror to reflect the virtual environment and can be used to increase the perceived viewing volume of the virtual environment and to permit multiple observers to simultaneously gain a perspectively correct impression of the virtual environment

The method is based on the fact that a planar mirror enables us to perceive the reflection of stereoscopically projected virtual scenes three-dimensionally. Instead of computing the stereo images that are projected onto surface 1311 on the basis of the positions of the user's physical eyes (as it is usually done for head tracking), the stereo images that are projected onto the portion of surface 1311 that is reflected in the planar mirror must be computed on the basis of the positions of the reflection of the user's eyes in the reflection space (i.e. the space behind the mirror plane). Because of the symmetry between the real world and its reflected image, the physical eyes perceive the same perspective by looking from the physical space through the mirror plane into the reflection space, as the reflected eyes do by looking from the reflection space through the mirror plane into the physical space. This is shown at 1701 in FIG. 17. Mirror 1703 defines a plane 1705 which divides what a user's physical eye 1713 sees into two spaces: physical space 1709, to which physical eye 1713 and physical projection plane 1717 belong, and reflection space 1707, to which reflection 1711 of physical eye 1713 and reflection 1715 of physical projection plane 1717 appear to belong when reflected in mirror 1703. Because reflection space 1707 and physical space 1709 are symmetrical, the portion of the virtual environment that physical eye 1713 sees in mirror 1703 is the portion of the virtual environment that reflected eye 1711 would see if it were looling through mirror 1703.

Thus, in order to determine the portion of physical projection plane 1717 that will be reflected to physical eye 1713 in mirror 1703 and the point of view from which physical eye 1713 will see the virtual reality projected on that portion of physical projection plane 1716, virtual reality system program 1309 need only know the position and orientation of physical eye 1713 and the size and position of mirror 1703. Using this information, virtual reality system program 1309 can determine the position and orientation of reflected eye 1711 in reflected space 1707 and from that, the portion of physical projection plane 1717 that will be reflected and the point of view which determines the virtual environment to be produced on that portion of physical projection plane 1717.

If mirror plane 1705 is represented as:

f(y,z)=ax+by+cz+d=0,

with its normal vector \vec{N}=[a,b,c]

then the reflection of a point (in physical space coordinates) can be calculated as follows:

$${\vec{P}}^{′} = \vec{P} - \frac{2}{( {\vec{N}}^{2} )} ( \vec{N} \vec{P} + d ) \vec{N} ,$$

where \vec{p} is the physical point and \vec{p} its reflection. To make use of the binocular parallax, the reflections of both eyes have to be determined. In contrast to head tracldng, the positions of the reflected eyes are used to compute the stereo images, rather than the physical eyes.

We can apply the reflection theorem to compute a vector's reflector:

\vec{L}=2(\vec{NL})\vec{N}−\vec{L},

where \vec{L} is the reflector of \vec{L}.

If \vec{E} is the user's generalized physical eye position and \vec{x} a visible point on the mirror plane, then

$$\vec{L} = \frac{\vec{E} - \vec{X}}{\vert \vec{E} - \vec{X} \vert} .$$

Hence, we can compute the visible points that are projected onto physical projection plane 1717 (g(x,y,z)=0) and are reflected by mirror plane 1705 (f(x,y,z)=0) as follows:

R={\vec{Y}|\vec{Y}=\vec{X}+λ\vec{L},g(\vec{Y})=0,f(\vec{X})=0},

where \vec{X} is the point on the mirror plane that is visible to the user, and \vec{Y} is the point on the projection plane that is reflected towards the user at \vec{X}.

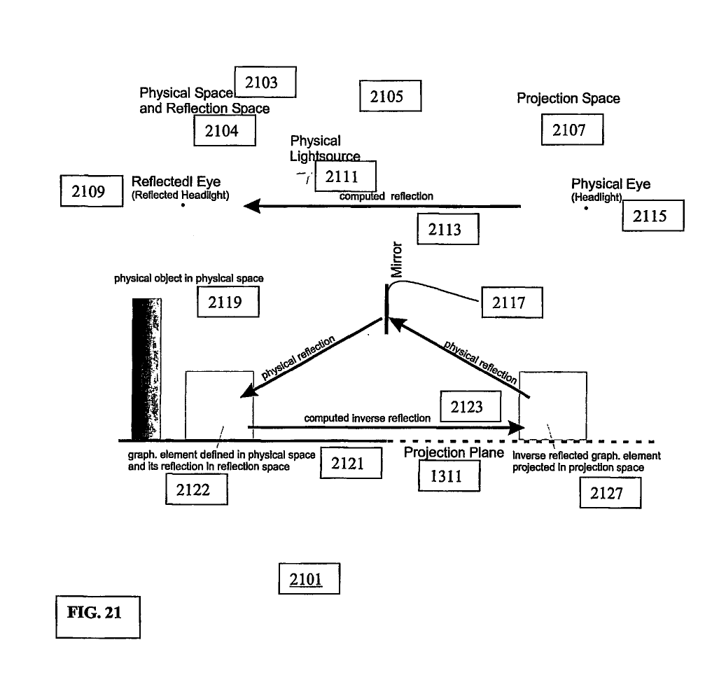

Using Transflective Tools With Virtual Environments: FIGS. 21-23

When the reflecting pad is made using a clear panel and film such as Scotchtint P-18, it is able not only to alternatively transmit light and reflect light, but also able to do both simultaneously, that is, to operate transflectively. A pad with this capability can be used to augment the image of a physical object seen through the clear panel by means of virtual objects produced on is projection plane 1311 and reflected by the transflective pad. This will be described with regard to FIG. 21.

In FIG. 21, the plane of transflective pad 2117 divides environment 2101 into two subspaces. We will call subspace 2107 that contains the viewer's physical eyes 2115 and (at least a large portion of) projection plane 1311 ‘the projection space’ (or PRS), and subspace 2103 that contains physical object 2119 and additional physical light-sources 2111 ‘the physical space’ (or PHS). Also defined in physical space, but not actually present there, is virtual graphical element 2121. PHS 2103 is exactly overlaid by reflection space 2104, which is the space that physical eye 2115 sees reflected in mirror 2117. The objects that physical eye 2115 sees reflected in mirror 2117 are virtual objects that the virtual environment system produces on projection plane 1311. Here, the virtual environment system uses the definition of virtual graphical element 2121 to produce virtual graphical element 2127 at a location and orientation on projection plane 1311 such that when element 2127 is reflected in mirror 2117, the reflection 2122 of virtual graphical element 2127 appears in reflection space 2104 at the location of virtual graphical element 2121. Since mirror 2117 is transflective, physical eye 2115 can see both physical object 2119 through mirror 2117 and virtual graphical element 2127 reflected in mirror 2117 and consequently, reflected graphical element 2122 appears to physical eye 2115 to overlay physical object 2119.

We apply stereoscopic viewing and head-tracking to virtual graphical element 2127 projected onto projection plane 1311, thus all graphical elements (geometry, virtual light-sources, clipping-planes, normals, etc) are defined in the virtual scene. The exact overlay of physical space 2103 and reflection space 2104 is achieved by providing the virtual environment system with the location and orientation of physical object 2119, the definition of graphical element 2121, the location and orientation of mirror 2117, and the location and direction of view of physical eye 2115. Using this information, the virtual environment system can compute projection space 2107 as shown by arrows 2113 and 2123. The virtual environment system computes the location and direction of view of reflected eye 2109 from the location and direction of view of physical eye 2115 and the location and orientation of mirror 2117 (as shown by arrow 2113). The virtual environment system computes the location of inverse reflected virtual graphical element 2127 in projection space 2107 from the location and point of view of reflected eye 2109, the location and orientation of mirror 2117, and the definition of virtual graphical element 2121, as shown by arrow 2123. In general, the definition of virtual graphical element 2121 will be relative to the position and orientation of physical object 2119. The virtual environment system then produces inverse reflected virtual graphical element 2127 on projection plane 1311, which is then reflected to physical eye 2115 by mirror 2117. Since reflection space 2104 exactly overlays physical space 2103, the reflection 2122 of virtual graphical element 2127 exactly overlays defined graphical element 2121. In a preferred embodiment, physical object 2119 has a tracking device and a spoken command is used to indicate to the virtual environment system that the current location and orientation of physical object 2119 are to be registered in the coordinate system of the virtual environment being projected onto projection plane 1311. Since graphical element 2121 is defined relative to physical object 2119, registration of physical object 2119 also defines the location and orientation of graphical element 2121. In other embodiments, of course, physical object 2119 may be continually tracked.

The technique described above can be used to augment a physical object 2119 in PHS 2103 with additional graphical elements 2127 that are produced on projection plane 1311 and reflected in transflective mirror 2117 so that they appear to physical eye 2115 to be in the neighborhood of physical object 2119, as shown at 2121. Transflective mirror 2117 thus solves an important problem of back-projection environments, namely that the presence of physical objects in PRS 2107 occludes the virtual environment produced on projection plane 1311 and thereby destroys the stereoscopic illusion. When the above technique is used, the virtual elements will always overlay the physical objects.

More precisely, if we compute (arrow 2113) the reflection of physical eye 2115 in mirror 2117 to obtain reflected eye 2109 (as well as possible virtual head-lights) and apply the inverse reflection 2123 to every virtual element 2121 that is to appear in PHS 2103, virtual element 2121 gets projected at 2127, its corresponding inverse reflected position within PRS 2107, and physically reflected back by mirror 2117 so that it appears to physical eye 2115 to be in reflection space 2104. Since, in this case, reflection space 2104 exactly overlays PHS 2103, the reflected virtual element 2127 will appear at the same position (2122) within the reflection space as virtual element 2121 would occupy within PHS 2103 if virtual element 2121 were real and PHS 2103 were being viewed by physical eye 2115 without mirror 2117.

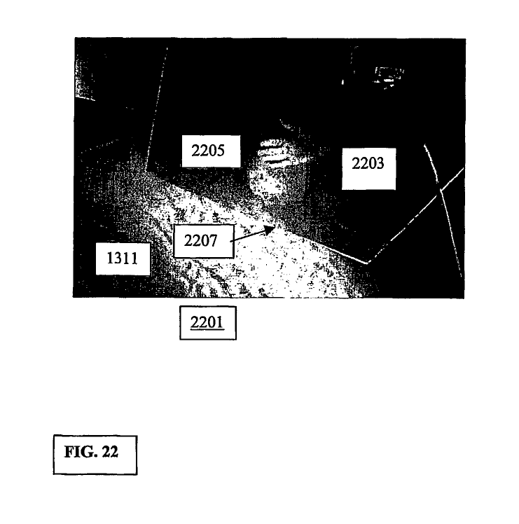

FIG. 22 illustrates a simple first example at 2201. A virtual sphere 2205 is produced on projection plane 1311. If hand 2203 is held between the viewer's eyes and projection plane 1311, hand 2203 occludes sphere 2205. If transflective mirror 2207 is placed between hand 2203 and the viewer's eyes in the proper position, the virtual environment system will use the position of transflective mirror 2207, the original position of sphere 2205 on projection plane 1311, and the position of the viewer's eyes to produce a new virtual sphere at a position on projection plane 1311 such that when the viewer looks at transflective mirror 2207 the reflection of the new virtual sphere in mirror 2207 appears to the viewer to occupy the same position as the original virtual sphere 2205; however, since mirror 2207 is infront of hand 2203, hand 2203 cannot occlude virtual sphere 2205 and virtual sphere 2205 overlays hand 2203.

The user can intuitively adjust the ratio between transparency and the reflectivity by changing the angle between transflective mirror 2207 and projection plane 1311. While acute angles highlight the virtual augmentation, obtuse angles let the physical objects show through brighter. As for most augmented environments, a proper illumination is decisive for a good quality. The technique would of course also work with fixed transflective mirrors 2207.

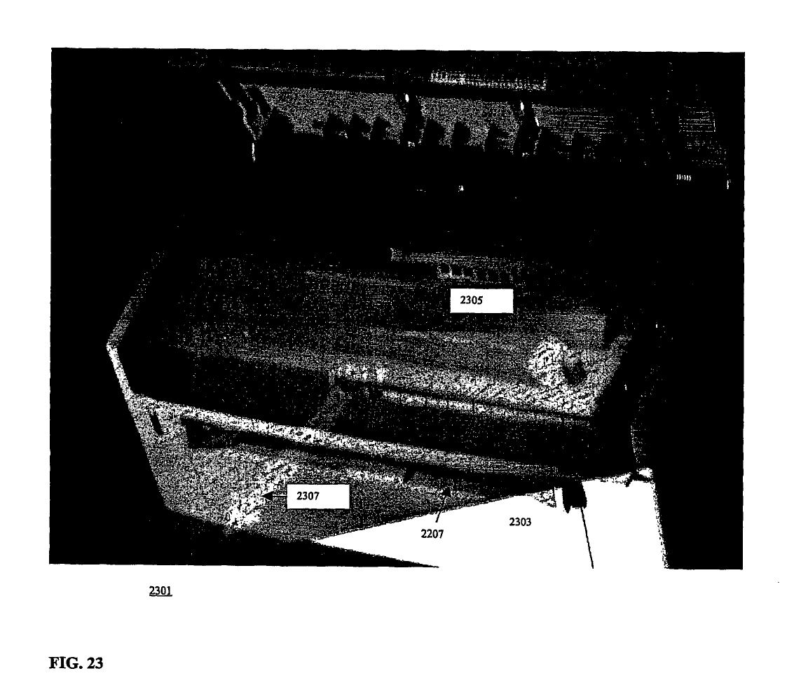

FIG. 23 shows an example of how a transflective mirror might be used to augment a transmitted image. Here, physical object 2119 is a printer 2303. Printer 2303's physical cartridge has been removed. Graphical element 2123 is a virtual representation 2305 of the printer's cartridge which is produced on projection plane 1311 and reflected in transflective mirror 2207. Printer 2303 was registered in the coordinate system of the virtual environment and the virtual environment system computed reflection space 2104 as described above so that it exactly overlays physical space 2103. Thus, virtual representation 2305 appears to be inside printer 2303 when printer 2303 is viewed through transflective mirror 2207. Because virtual representation 2305 is generated on projection plane 1311 according to the positions of printer 2303, physical eye 2115, and mirror 2117, mirror 2117 can be moved by the user and the virtual cartridge will always appear inside printer 2303. Virtual arrow 2307, which shows the direction in which the printer's cartridge must be moved to remove it from printer 2303 is another example of augmentation. Like the virtual cartridge, it is produced on projection plane 1311. Of course, with this technique, anything which can be produced on projection plane 1311 can be use to augment a real object.

To create reflection space 2104, the normal/inverse reflection must be applied to every aspect of graphical element 2127, including vertices, normals, clipping planes, textures, light sources, etc., as well as to the physical eye position and virtual head-lights. Since these elements are usually difficult to access, hidden below some internal data-structure (generation-functions, scene-graphs, etc.), and an iterative transformation would be too time-intensive, we can express the reflection as a 4×4 transformation matrix. Note that this complex transformation cannot be approximated with an accumulation of basic transformations (such as translation, rotation and scaling).

Let f(x, y, z)=ax+by+cz+d be the mirror-plane, with its normal \vec{N}=[a, b, c] and its offset d. Then the reflection matrix is:

$$M = \frac{1}{{{N}^{->}}^{2}} [ \begin{matrix}{b}^{2} + {c}^{2} - {a}^{2} & - 2 ab & - 2 a c & - 2 ad \\ - 2 ab & {a}^{2} + {c}^{2} - {b}^{2} & - 2 bc & - 2 bd \\ - 2 a c & - 2 bc & {a}^{2} + {b}^{2} - {c}^{2} & - 2 c d \\ 0 & 0 & 0 & {{N}^{->}}^{2}\end{matrix} ]$$

By applying the reflection matrix, every graphical element will be reflected with respect to the mirror-plane. A side-effect of this is, that the order of polygons will also be reversed (e.g. from counterclockwise to clockwise) which, due to the wrong front-face determination, results in a wrong rendering (e.g. lighting, culling, etc.). This can easily be solved by explicitly reversing the polygon order.

How this is done is shown in the following example in source code that uses the OpenGL graphical API. Details of this API may be found at www.opengl.org.

| | |
|---|---|
| ... | |
| glFrontFace(GL_CW); | // set polygon order to clockwise |
| | // (OpenGL default: counterclockwise) |
| glPushMatrix( ); | // backup current transformation matrix |

| | |
|---|---|
| glMultMatrixd(M); | // apply reflection matrix |
| renderEverything( ); | // render all graphical elements that have to |

// be reflected (with respect to reflected eye
// position and reflected headlights)

| | |
|---|---|
| glPopMatrix( ); | // restore transformation matrix |

| | |
|---|---|
| glFrontFace(GL_CCW); | // set polygon order back to default |
| | // (counterclockwise) |
| ... | |

Any complex graphical element (normals, material properties, textures, text, clipping planes, light sources, etc.) is reflected by applying the reflection matrix, as shown in the pseudo-code above.

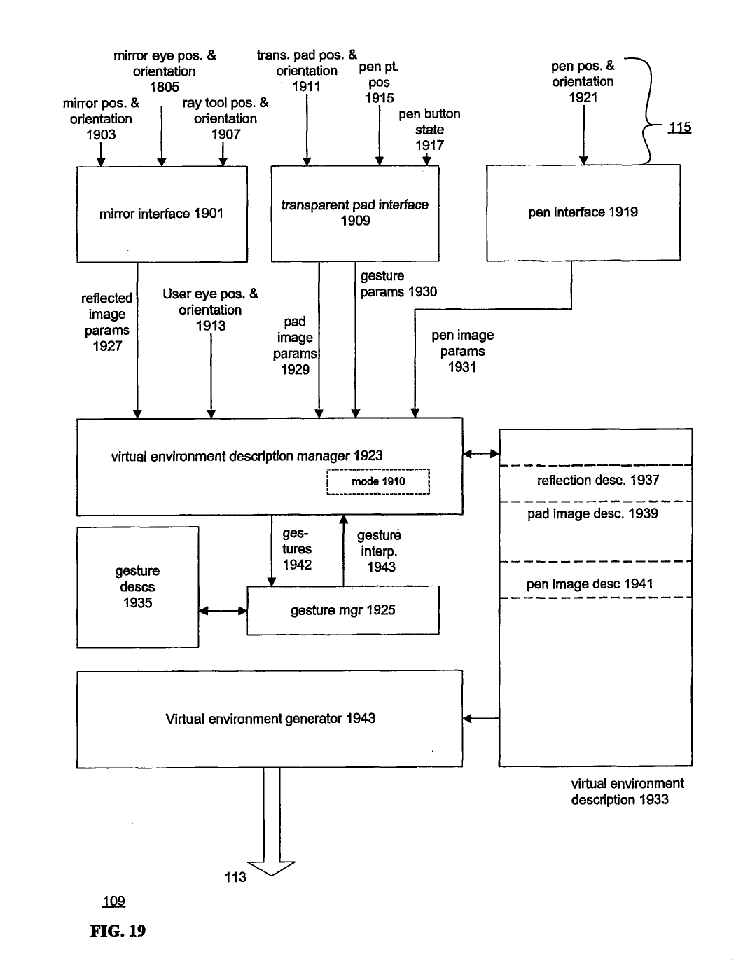

Overview of Virtual Reality System Program 1309: FIG. 19

Virtual reality system program 1309 in system 1301 is able to deal with inputs of the user's eye positions and locations together with position and orientation inputs from transparent pad 1323 to make pad image 1325, with position and orientation inputs from pen 1321 to make projected pen 1327, with inputs from pen 1321 as applied to pad 1323 to perform operations on the virtual environment, and together with position and orientation inputs from a mirror to operate on the virtual environment so that the mirror reflects the virtual environment appropriately for the mirror's position and orientation and the eye positions. All of these inputs are shown at 1315 of FIG. 13. As also shown at 1313 in FIG. 13, the resulting virtual environment is output to virtual table 1311.

FIG. 19 provides an overview of major components of program 1309 and their interaction with each other. The information needed to produce a virtual environment is contained in virtual environment description 1933 in memory 1307. To produce the virtual environment on virtual table 1311, virtual environment generator 1943 reads data from virtual environment description 1933 and makes stereoscopic images from it. Those images are output via 1313 for back projection on table surface 1311. Pad image 1325 and pen image 1327 are part of the virtual environment, as is the portion of the virtual environment reflected by the mirror, and consequently, virtual environment description 1933 contains a description of a reflection (1937), a description of the pad image (1939), and a description of the pen image (1941).

Virtual, environment description 1933 is maintained by virtual environment description manager 1923 in response to parameters 1913 indicating the current position and orientation of the user's eyes, parameters 1927, 1929, 1930, and 1931 from the interfaces for the mirror (1901), the transparent pad (1909), and the pen (1919), and the current mode of operation of the mirror and/or pad and pen, as indicated in mode specifier 1910. Mirror interface 1901 receives mirror position and orientation information 1903 from the mirror, eye position and orientation information 1805 for the mirror's viewer, and if a ray tool is being used, ray tool position and orientation information 1907. Mirror interface 1901 interprets this information to determine the parameters that virtual environment description manager 1923 requires to make the image to be reflected in the mirror appear at the proper point in the virtual environment and provides the parameters (1927) to manager 1923, which produces or modifies reflection description 1937 as required by the parameters and the current value of mode 1910. Changes in mirror position and orientation 1903 may of course also cause mirror interface 1901 to provide a parameter to which manager 1923 responds by changing the value of mode 1910.

The Extended Virtual Table

The extended virtual table disclosed in PCT/US01/18327 has a large half-silvered mirror attached to one end of a virtual workbench. The mirror can be used in two ways: to extend the virtual reality created by the workbench's projector or to augment an object behind the mirror with the virtual reality created by the workbench's projector.

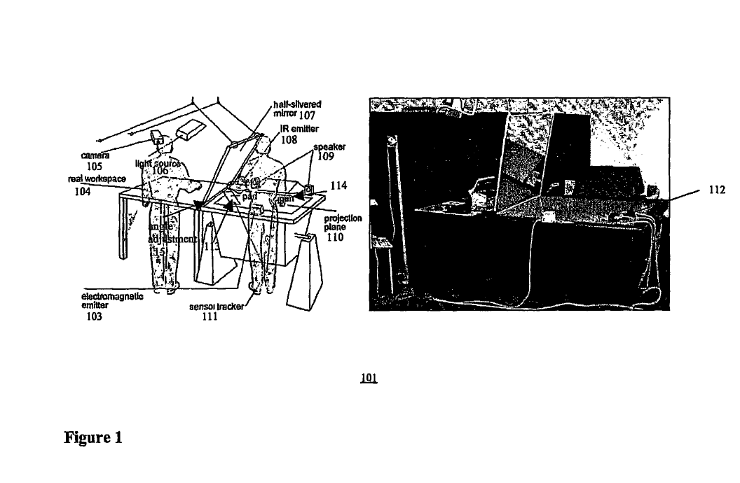

Physical Arrangement of the Extended Virtual Table: FIG. 1

The Extended Virtual Table (xVT) prototype 101 consists of a virtual 110 and a real workbench 104 (cf. FIG. 1).

A Barco BARON (2000a) 110 serves as display device that projects 54″×40″ stereoscopic images with a resolution of 1280×1024 (or optionally 1600×1200/2) pixels on the backside of a horizontally arranged ground glass screen 110. Shutter glasses 112 such as Stereographics' CrystalEyes (StereoGraphics, Corp., 2000) or NuVision3D's 60GX (NuVision3D Technologies, Inc. 2000) are used to separate the stereo-images for both eyes and make stereoscopic viewing possible. In addition, an electromagnetic tracking device 103/111 Ascension's Flock of Birds (Ascension Technologies. Corp., 2000) is used to support head tracking and tracking of spatial input devices (a pen 114 and a pad 115). An Onyx InfiniteReality², which renders the graphics is connected (via a TCP/IP intranet) to three additional PCs that perform speech-recognition, speech-synthesis via stereo speakers 109, gesture-recognition, and optical tracking.

A 40″×40″ large, and 10 mm thick pane of glass 107 separates the virtual workbench (i.e. the Virtual Table) from the real workspace. It has been laminated with a half-silvered mirror foil 3M's Scotchtint P-18 (3M, Corp., 2000) on the side that faces the projection plane, making it behave like a front-surface mirror that reflects the displayed graphics. We have chosen a thick plate glass material (10 mm) to minimize the optical distortion caused by bending of the mirror or irregularities in the glass. The half-silvered mirror foil, which is normally applied to reduce window glare, reflects 38% and transmits 40% light. Note that this mirror extension costs less than $100. However, more expensive half-silvered mirrors with better optical characteristics could be used instead (see Edmund Industrial Optics (2000) for example).

With the bottom leaning onto the projection plane, the mirror is held by two strings which are attached to the ceiling. The length of the strings can be adjusted to change the angle between the mirror and the projection plane, or to allow an adaptation to the Virtual Table's slope 115.

A light-source 106 is adjusted in such a way that it illuminates the real workbench, but does not shine at the projection plane.

In addition, the real workbench and the walls behind it have been covered with a black awning to absorb light that otherwise would be diffused by the wall covering and would cause visual conflicts when the mirror is used in a see-through mode.

Finally, a camera 105, a Videum VO (Winnov, 2000) is applied to continuously capture a video-stream of the real workspace, supporting an optical tracking of paper-markers that are placed on top of the real workbench.

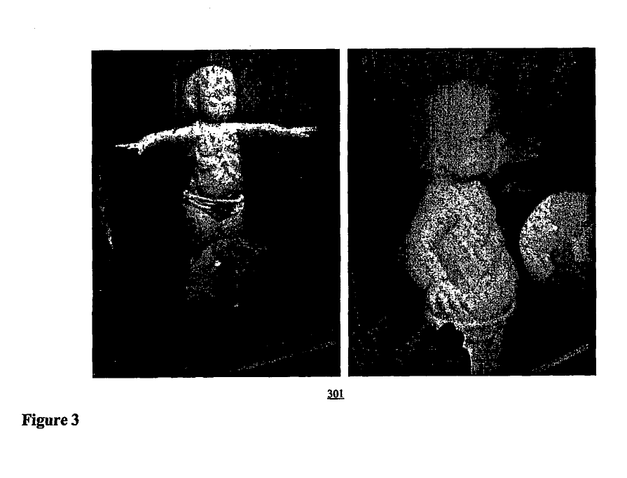

General Functioning: FIGS. 2-3

Users can either work with real objects above the real workbench, or with virtual objects above the virtual workbench.

Elements of the virtual environment, which is displayed on the projection plane, are spatially defined within a single world-coordinate system that exceeds the boundaries of the projection plane, covering also the real workspace.

The mirror plane 203 splits this virtual environment into two parts that cannot be simultaneously visible to the user. This is due to the fact that only one part can be displayed on the projection plane 204. We determine the user's viewing direction to support an intuitive visual extension of the visible virtual environment. If, on the one hand, the user is looking at the projection plane, the part of the environment 205 is displayed that is located on the user's side of the mirror (i.e. the part that is located over the virtual workbench). If, on the other hand, the user is looking at the mirror, what is displayed on projection plane 204 and reflected in the mirror is the part of the environment 206 located on the side of the mirror that is away from the user. Though that part of the environment is reflected in the mirror, it is transformed, displayed and reflected in such a way that it appears as the continuation of the other part in the rmirror, i.e., the mirror appears to the user to be a window into the part of the virtual environment on the other side of the mirror.

Using the information from the head tracker, the user's viewing direction 207 is approximated by computing the single line of sight that originates at her point of view and points towards her viewing direction. The plane the user is looking at (i.e. projection plane or mirror plane) is then the one, which is first intersected by this line of sight. If the user is looking at neither plane, no intersection can be determined and nothing needs to be rendered at all.

In case the user is looking at the mirror, the part of the virtual environment behind the mirror has to be transformed in such a way that, if displayed and reflected, it appears stereoscopically and perspectively correct at the right place behind the mirror. As with the hand-held transflective pad described in (Binber, Encarnação & Schmalstieg, 2000b, PCT patent application PCT/US99/28930), we use an affine transformation matrix to reflect the user's viewpoint (i.e. both eye positions that are required to render the stereo-images), and to inversely reflect the virtual environment over the mirror plane.

If we inversely reflect the graphical content from the side of the mirror away from the user and render it from the viewpoint that is reflected vice versa, the projected virtual environment will not appear as reflection in the mirror. The user rather sees the same scene that she would perceive without the mirror if the projection plane were large enough to visualize the entire environment. This is due to the neutralization of the computed inverse reflection by the physical reflection of the mirror.

Note that the transformation matrix can simply be added to a matrix stack or integrated into a scene graph without increasing the computational rendering cost, but since its application reverses also the polygon order (which might be important for correct front-face determination, lighting, culling, etc.), appropriate steps have to be taken in advance (e.g., explicitly reversing the polygon order before reflecting the scene).

The plane parameters (a,b,c,d) can be determined within the world coordinate system in different ways:

The electromagnetic tracking device can be used to support a three-point calibration of the mirror plane.

The optical tracking system can be applied to recognize markers that are (temporarily or permanently) attached to the mirror.

Since the resting points of the mirror on the projection plane are known and do not change, its angle can be measured using a simple ruler.

Note that all three methods can introduce calibration errors—either caused by tracking distortion (electromagnetic or optical) or caused by human inaccuracy. Our experiments have shown that the optical method is most precise and less vulnerable to errors.

To avoid visual conflicts between the projection and its corresponding reflection—especially for areas of the virtual environment whose projections are close to the mirror—we optionally render a clipping plane that exactly matches the mirror plane (i.e. with the same plane parameters a,b,c,d). Visual conflicts arise if virtual objects spatially intersect the side of the user's viewing frustum that is adjacent to the mirror, since in this case the objects projection optically merges into its reflection in the mirror. The clipping plane culls away the part of the virtual environment that the user is not looking at (i.e. we reverse the direction of the clipping plane, depending on the viewer's viewing direction while maintaining its position). The result is a small gap between the mirror and the outer edges of the viewing frustum in which no graphics is visualized. This gap helps to differentiate between projection and reflection and, consequently, avoids visual conflicts. Yet, it does not allow virtual objects which are located over the real workbench to reach through the mirror. We can optionally activate or deactivate the clipping plane for situations where no, or minor visual conflicts between reflection and projection occur to support a seamless transition between both spaces.

If the real workspace behind the mirror beam-splitter is not illuminated 201, the mirror behaves like a full mirror and supports a non-simultaneous visual extension of an exclusively virtual environment (i.e. both parts of the environment cannot be seen at the same time). FIG. 2 shows a large coherent virtual scene whose parts can be separately observed by either looking at the mirror 203 or at the projection plane 204. In this case, what is seen is a life-size human body for medical training viewed in the mirror (left), or on the projection plane (right). The real workspace behind the mirror is not illuminated.

Note that none of the photographs shown in the Figures are embellished. They were taken as seen from the viewer's perspective (rendered monoscopically). However, the printouts may appear darker and with less luminance than in reality (mainly due to the camera-response).

FIG. 3 shows a simple example in which the mirror beam-splitter is used as an optical combiner. If the real workspace is illuminated, both the real and the virtual environment are visible to the user and real and virtual objects can be combined in AR-manner 301:

Left: Real objects behind the mirror (the ball) are illuminated and augmented with virtual objects (the baby). The angle between mirror and projection plane is 60°.

Right: Without attaching a clipping plane to the mirror, the baby can reach her arm through the mirror. The angle between mirror and projection plane is 80°.

Note that the ratio of intensity of the transmitted light and the reflected light depends on the angle 115 between beam-splitter and projection plane. While acute angles highlight the virtual content, obtuse angles 115 let the physical objects shine through brighter.

Distortion Compensation and Correction

Optical Distortion

Optical distortion is caused by the elements of an optical system. It does not affect the sharpness of a perceived image, but rather its geometry and can be corrected optically (e.g., by applying additional optical elements that physically rescind the effect of other optical elements) or computationally (e.g., by pre-distorting generated images). While optical correction may result in heavy optics and non-ergonomic devices, computational correction methods might require high computational performance.

In Augmented Reality applications, optical distortion is critical, since it prevents precise registration of virtual and real enviromnent.

The purpose of the optics used in HMDs, for instance, is to project two equally magnified images in front of the user's eyes, in such a way that they fill out a wide field-of-view NOV), and fall within the range of accommodation (focus). To achieve this, however, lenses are used in front of the miniature displays (or in front of mirrors that reflect the displays within see-through HMDs). The lenses, as well as the curved display surfaces of the miniature screens may introduce optical distortion which is normally corrected computationally to avoid heavy optics which would result from optical approaches.

For HMDs, the applied optics forms a centered (on-axis) optical system; consequently, pre-computation methods can be used to efficiently correct geometrical aberrations during rendering.

Rolland and Hopkins (1993) describe a polygon wrapping technique as a possible correction method for HMDs. Since the optical distortion for HMDs is constant (because the applied optics is centered), a two-dimensional lookup table is pre-computed that maps projected vertices of the virtual objects' polygons to their pre-distorted location on the image plane. Note that this requires subdividing polygons that cover large areas on the image plane. Instead of pre-distorting the polygons of projected virtual objects, the projected image itself can be pre-distorted, as described by Watson and Hodges (1995), to achieve a higher rendering performance.

Correcting optical distortion is more complex for the mirror beam-splitter extension, since in contrast to HMs, the image plane that is reflected by the mirror is not centered with respect to the optical axes of the user, but is off-axis in most cases. In fact, the alignment of the reflected image plane dynamically changes with respect to the moving viewer while the image plane itself remains at a constant spatial position in the environment. There are three main sources of optical distortion in case of the xVT: projector calibration, mirror flexion, and refraction.

Note that we correct optical distortion only while the user is working in the see-through mode (i.e. while looking through the half-silvered mirror at an illuminated real environment). For exclusive VR applications, optical distortion is not corrected—even if the mirror is used as an extension.

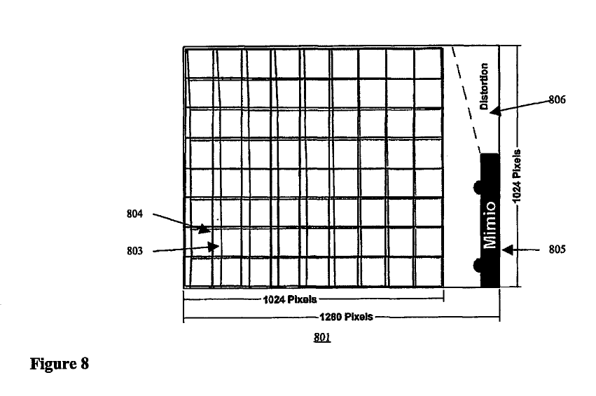

Projector Calibration: FIG. 8

The projector that is integrated into the Virtual Table can be calibrated in such a way that it projects distorted images onto the ground glass screen. Projector-specific parameters (such as geometry, focus, and convergence) can usually be adjusted manually or automatically using camera-based calibration devices. While a precise manual calibration is very time consuming, an automatic calibration is normally imprecise and most systems do not offer a geometry calibration (only calibration routines for convergence and focus).

For exclusive VR purposes, however, we can make use of the fact, that small geometric deviations are ignored by the human-visual system. In AR scenarios, on the other hand, even slight misregistrations can be sensed.

FIG. 8 shows the calibration technique. We apply a two-pass method and render a regular planar grid 803 (U) that largely covers the projection plane. The distorted displayed grid is then sampled with a device 805 that is able measure 2D points on the tabletop. After a transformation of the sampled grid (D) into the world coordinate system, it can be used to pre-distort the projected image, since with D the geometrical deviation (U−D) which is caused by the miscalibrated projector can be expressed. A pre-distorted grid 804 (P) can then be computed with P=U+(U−D). If we project P instead of U, the pre-distortion is rescinded by the physical distortion of the projector and the visible grid appears undistorted.

To pre-distort the projected images, however, we first render the virtual environment into the frame-buffer, then map the frame-buffer's content as texture ontoP (while retaining the texture indices of U and applying a bilinear texture-filter), and render P into the beforehand cleaned frame-buffer, as described by Watson and Hodges (1995) for HMDs. Note that this is done for both stereo-images at each frame.

To sample grid points, we apply a device that is usually used to track pens on a white-board—the Mimio 805 (Dunkane, Corp. 2000). The Mimio is a hybrid (ultrasonic and infrared) tracking system for planar surfaces which is more precise and less susceptible to distortion than the applied electromagnetic tracking device. As illustrated in FIG. 8, its receiver 805 has been attached to a corner of the Virtual Table (note the area where the Mimio cannot receive correct data from the sender, due to distortion—this area 806 has been specified by the manufacturer). Since the supported maximal texture size of the used rendering package is 1024×1024 pixels, U is rendered within the area (of this size) that adjoins to the mirror. We found that 10×9 sample points for an area of 40″×40″ on the projection plane is an appropriate grid resolution which avoids over-sampling but is sufficient enough to capture the distortion.

FIG. 8 illustrates the sampled distorted grid D 803 (gray), and the pre-distorted grid P 804 (black) after it has been rendered and re-sampled. Note that FIG. 8 shows real data from one of the calibration experiments (other experiments delivered similar results).

The calibration procedure has to be done once (or once in a while—since the distortion behavior of the projector can change over time).

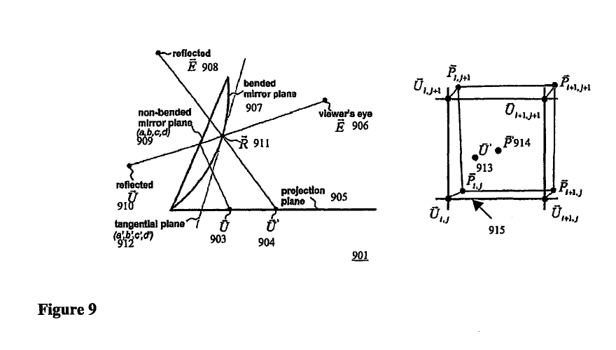

Mirror Flexion: FIG. 9

For the mirror beam-splitter, a thick plate glass material has been selected to keep optical distortion caused by bending small. Due to gravity, however, a slight flexion affects the 1st order imaging properties of our system (i.e. magnification and location of the image) and consequently causes a deformation of the reflected image that cannot be avoided.

FIG. 9—left illustrates the optical distortion caused by flexion. A bent mirror does not reflect the same projected pixel for a specific line of sight as a non-bent mirror.

Correction of the resulting distortion can be realized by transforming the pixels from the position where they should be seen (reflected by an ideal non-bent mirror) to the position where they can be seen (reflected by the bent mirror) for the same line of sight.

Since a transformation of every single pixel would be inefficient, the correction of mirror flexion can be combined using the method described above.

For every point \vec{U} 903 of the undistorted grid U, the corresponding point of reflection \vec{R} 911 on the bent mirror 907 has to be determined with respect to the current eye position of the viewer \vec{E} 906. Note that this requires knowledge of the mirror's curved geometry. If the surface of the mirror is known, \vec{R} 911 can simply be calculated by reflecting \vec{U} 903 over the known (non-bent) mirror plane 907 (the reflection matrix, described by Bimber, Encarnação & Schmalstieg, 2000b, PCT patent application PCT/US99/28930 can be used for this), and then find the intersection between the bent mirror's surface and the straight line that is spanned by \vec{E} 906 and the reflection of \vec{U} 910. Note that if the mirror's entire surface is not known, an interpolation between sample points (taken from the mirror's surface) can be done to find an appropriate \vec{R} 911. If \vec{R} 911 has been determined, the normal vector at \vec{R} has to be computed (this is also possible with the known mirror-geometry). The normal vector usually differs from the normal vector (a,b,c) of the non-bent mirror (which is the same for every point on the non-bent mirror's surface). With the computed \vec{R} 911 and its normal, the equation parameters (a′,b′,c′,d′) for a plane that is tangential to \vec{R} 912 are identified. To compute the position where \vec{U} 903 has to be moved on the projection plane to be visible for the same line of sight in the bent mirror, \vec{E} has to be reflected over (a′,b′, c′,d′). The intersection between the projection plane and the straight line that is spanned by the reflection of \vec{E} 908 and \vec{R} 911 is \vec{U}′ 904.

However, it is not sufficient to transform the undistorted grid with respect to the mirror's flexion and the observer's viewpoint only, because the projector distortion (described in 5.1.1) is not taken into account. To imply projector distortion, every \vec{U}′ 904 has to be pre-distorted, as described in the previous section. Since the \vec{U}′s normally do not match their corresponding \vec{U}s, and a measured distortion \vec{D}′ for each \vec{U}′ does not exist, an appropriate pre-distortion offset can be interpolated from the measured (distorted) grid D (as illustrated in FIG. 9—right). This can be done by bilinear interpolating between the corresponding points of the pre-distorted grid P that belongs to the neighboring undistorted grid points of U which form the cell 915 that encloses \vec{U}′ 913.

In summary, we have to compute a new pre-distorted grid P′ 914 depending on the mirror's flexion R 911, the current eye-positions of the viewer \vec{E} 906, and the projector distortion D.

The resulting P′ 914 can then be textured, as described in the previous section (for both stereo-images at each frame).

Note that finding an exact method of precisely determining the mirror's flexion belongs to our future research. Using the electromagnetic tracking-device to sample the mirror's surface turned out to be insufficient, due to the non-linear tracking distortion over the extensive area.

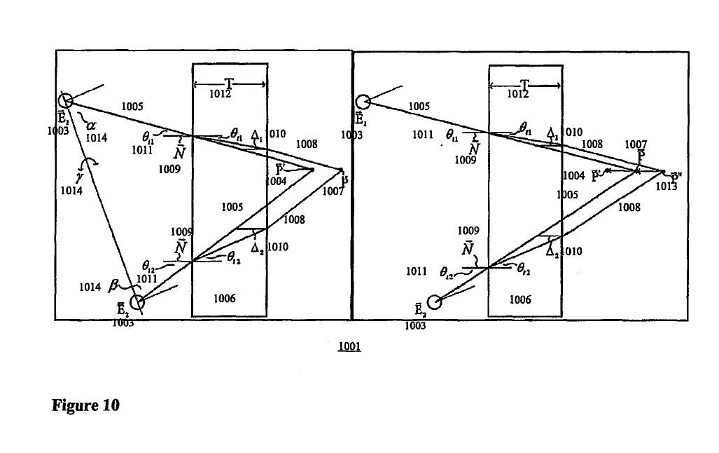

Refraction: FIG. 10

On the one hand, a thick pane of glass stabilizes the mirror and consequently minimizes optical distortion caused by flexion. On the other hand, however, it causes another optical distortion which results from refraction. Since the transmitted light that is perceived through the half-silvered mirror is refracted, but the light that is reflected by the front surface mirror foil is not, the transmitted image of the real environment cannot be precisely registered to the reflected virtual environment—even if their geometry and alignment match exactly within the world coordinate system.

All optical systems that use any kind of see-through elements have to deal with similar problems. While for HMDs, aberrations caused by refraction of the lenses are mostly assumed to be static (as stated by Azuma (1997)), they can be corrected with paraxial analysis approaches. For other setups, such as the reach-in systems that were previously mentioned or our mirror extension, aberrations caused by refraction are dynamic, since the optical distortion changes with a moving viewpoint. Wiegand et al. (1999) for instance, estimated the displacement caused by refraction for their setup to be less than 1.5 mm—predominantly in +y-direction of their coordinate system. While an estimation of a constant refraction might be sufficient for their apparatus (i.e. a near-field virtual environment system with fixed viewpoint that applies a relatively thin (3 mm) half-silvered mirror), our setup requires a more precise definition, because it is not a near-field VE system but rather a mid-field VR/AR system, considers a head-tracked viewpoint, and applies a relatively thick half-silvered mirror (10 mm). Since we cannot pre-distort the refracted transmitted image of the real world, we artificially refract the reflected virtual world instead, to make both images match.

FIG. 10 illustrates our approaches.

With reference to FIG. 10—left: The observer's eyes (\vec{E}₁, \vec{E}₂) 1003 have to converge to see a point in space (\vec{P}′) 1004 in such a way that the geometric lines of sight (colored in black) 1005 intersect in \vec{P}′ 1004. If the observer sees through a medium 1006 whose density is higher than the density of air, the geometric lines of sight are bent by the medium and she perceives the point in space (\vec{P}) 1007 where the resulting optical lines of sight (colored in dark gray) 1008 intersect—i.e. she perceives \vec{P} 1007 instead of \vec{P}′ 1004 if refraction bends her geometric lines of sight 1003.

To artificially refract the virtual environment, our goal is to translate every point \vec{P} 1007 of the virtual environment to its corresponding point \vec{P}′ 1004—following the physical rules of refraction. Note that all points \vec{P} 1007 are virtual points that are not physically located behind the mirror beam-splitter, and consequently are not physically refracted by the pane of glass, but are reflected by the front surface mirror. The resulting transformation is curvilinear, rather than affine, thus a simple transformation matrix cannot be applied.

Using Snell's law for refraction, we can compute the optical line of sight for a corresponding geometric line of sight 1003. Note that in case of planar plates both lines of sight are simply shifted parallel along the plate's normal vector (\vec{N}) 1009, by an amount (Δ) 1010 that depends on the entrance angle (θᵢ) 1011 between the geometric line of sight and \vec{N} 1009, its thickness (T) 1012, and the refraction index (θ)—a material-dependent ratio that expresses the refraction behavior compared to vacuum (as an approximation to air).

The amount of translation (Δ) 1010 can be computed as follows:

$${θ}_{t} = {sin}^{- 1} ( \frac{sin {θ}_{i}}{η} )$$

Equation 1: Snell's Law of Refraction for Planar Plates of a Higher Density Than Air (Compared to Vacuum as Approximation to Air).

$$Δ = T ( 1 - \frac{tan {θ}_{t}}{tan {θ}_{i}} ) ,$$

Equation 2: Refraction-Dependent Amount of Displacement Along the Plate's Normal Vector.

With constant T (i.e. 10 mm) 1012 and constant η (i.e. 1.5 for regular glass), the refractor of a ray which is spanned by the two points (\vec{P}₁, \vec{P}₂) depends on the entrance angle (θᵢ) 1011 and can be computed as follows (in parameter representation):

$${R}^{->} = {{P}^{->}}_{1} + Δ \frac{{N}^{->}}{\vert {N}^{->} \vert} + λ ( {{P}^{->}}_{2} - {{P}^{->}}_{1} )$$

Equation 3: Refractor of a Ray That is Spanned by Two Points.

If the mirror is bent, as described above, the normal vector of the mirror plane is not constant and the corresponding normals of the points on the mirror surface that are intersected by the actual lines of sight have to be applied.

Note that the optical line of sight 1008 is the refractor that results from the geometric line of sight 1005 which is spanned by the viewer's eye (\vec{E}) 1003 and the point is space (\vec{P}) 1007 she's looking at.

In contrast to the optical distortions described in the previous sections, refraction is a spatial distortion and cannot be corrected within the image plane. Since no analytical correction methods exist, we apply a numerical minimization to precisely refract virtual objects that are located behind the mirror beam-splitter by transforming their vertices within the world coordinate system. Note that similar to Rolland's approach Holland & Hopkins, 1993), our method also requires subdividing large polygons of virtual objects to sufficiently express the refraction's curvilinearity.

The goal is to find the coordinate \vec{P}′ 1004 where the virtual vertex \vec{P} 1007 has to be translated in such a way that \vec{P} 1007 appears spatially at the same position as it would appear as real point, observed through the half-silvered mirror—i.e. refracted. To find \vec{P}′ 1004, we first compute the geometric lines of sight 1005 from each eye (\vec{E}₁,\vec{E}₂) 1003 to \vec{P} 1007. We then compute the two corresponding optical lines of sight 1008 using equation 3 and their intersection (\vec{P}″) 1013. During a minimization procedure (Powell's direction set method, Press et al., 1993) we minimize the distance between \vec{P} 1007 and \vec{P}″ 1013 while continuously changing the angles 1014 α, β (simulating the eyes' side-to-side shifts and convergence) and γ (simulating the eyes' up-and-down movements), and use them to rotate the geometric lines of side over the eyes' horizontal and vertical axes (the axes can be determined from the head-tracker). The rotated geometric lines of sight result in new optical lines of sight and consequently in a new \vec{P}″ 1013.

Finally, \vec{P}′ 1004 is the intersection of the (by some α,β,γ) 1014 rotated geometric lines of sight 1005 where |\vec{P}−\vec{P}″| is minimal (i.e. below some threshold ε). This final state is illustrated in FIG. 10.

In summary, we have to find the geometric lines of sight 105 whose refractors (i.e. the corresponding optical lines of sight) 1008 intersect in \vec{P} 1007 and then calculate the precise coordinate of \vec{P}′ 1004 as intersections of the determined geometric lines of sight 1005. Since \vec{P}′ 1004 is unknown, the resulting minimization problem is computationally expensive and cannot be solved in real-time.

To achieve a high performance on an interactive level, we implemented an approximation of the presented precise method.

With reference to FIG. 10—right: We compute the refractors of the geometric lines of sight to the vertex \vec{P} 1007 and their intersection \vec{P}″ 1013. Since the angular difference between the unknown geometric lines of sight 1005 to the unknown \vec{P}′ 1004 and the geometric lines of sight to \vec{P}″ 1013 is small, the deviations of the corresponding refractors are also small. We approximate \vec{P}′ with \vec{P}′=\vec{P}+(\vec{P}−\vec{P}″).

To compare the effectiveness of the outlined analytical approximation with the precise numerical method, we refracted vertices that covered the entire working volume behind the mirror beam-splitter over time (i.e. from different points of view) with both, the approximation and the precise method. The results are shown in table 1 (the minimization procedure was executed with a threshold of ε=0.01 mm).

The spatial distance between the approximately refracted points and their corresponding precisely refracted points serves as error function. The results are shown in table 2.

TABLE 1
Comparison between precise refraction and
approximated refraction.

| Displacement caused | | | |
|---|---|---|---|
| by refraction (mm) | Minimal | Maximal | Average |
| Precise Method | 3.75 | 10.34 | 6.08 |
| Approximation Method | 3.53 | 9.78 | 5.95 |

Note that the average deviation between the precise method and approximation is far below the average positional accuracy of the electromagnetic tracking device, as described in the next subsection. Thus, a higher optical distortion is caused by the inaccurate head-tracker than by applying the approximation to correct refraction misalignments. However, if refraction is not dealt with at all, the resulting optical distortion is higher than the one caused by tracking-errors.

Note also, that the presented approximation is only correct for plane parallel plates. If the mirror is bent, the normals at the intersections of the in-refractor and the out-refractor differ. However, we approximated this by assuming that the mirror's flexion is small and the two normals are roughly equivalent Determining both normals is computationally too expensive for interactive applications, and does not result in major visual differences in our system.

Nonoptical Distortion

Accurate registration requires accurate tracking. In addition to the non-linear tracking-distortion, end-to-end system delay (time difference between the moment that the tracking system measures a position/orientation and the moment the system reflects this measurement in the displayed image) or lag causes a “swimming effect” (virtual objects appear to float around real objects).

However, since ideal tracking devices do not yet exist, we apply smoothing filters (sliding average windows) to filter high-frequent sub-bands (i.e. noise) from the tracking samples and prediction filters (Kalman filters (Azuma, 1995)) for orientation information, and linear prediction for position information) to reduce the swimming effect.

The applied tracking device, Ascension's Flock of Birds (Ascension Technologies. Corp. 2000), provides a static positional accuracy of 2.5 mm (by 0.75 mm positional resolution), and a static angular accuracy of 0.5° (by 0.1° angular resolution). The highest update rate (without system delay) is 100 measurements/second.

Using Virtual Reality Systems and Mirrors to Build Virtual Showcases

The virtual reality systems and mirrors described in PCT/US99/28930 and PCT/US01/18327 can be used to build a new display device—the Virtual Showcase, which serves as both an Augmented Realty display and a Virtual Reality display and does so in both single-user and multi-user modes. After describing these different features of Virtual Showcases, we describe the associated rendering, transformation and image deformation techniques used for mirror configurations assembled from multiple planar sections or a single curved surface. References mentioned in the following discussion are listed following the Conclusion.

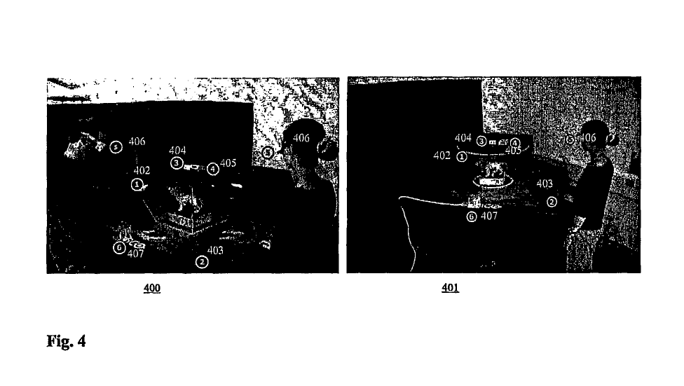

Physical Arrangements: FIG. 4

An important question in information technology is how virtial environments can be used to enhance established everyday environments that function well for their purposes, rather than simply replacing such environments. Augmented reality (AR) technology has a lot of potential in this respect, since it allows the augmentation of real world environments with computer generated imagery. At present, most Augmented Reality systems use see-through head mounted displays. Such displays share most of the disadvantages of standard head mounted displays. We present the Virtual Showcase, a new Augmented Reality display device that has the same form factor as the real showcases traditionally used for museum exhibits. Real scientific and cultural artifacts are placed inside the Virtual Showcase, where they can be augmented using three-dimensional graphical techniques. Inside the Virtual Showcase, virtual representations and real artifacts share the same space, thus providing new ways of merging and exploring real and virtual content. The virtual part of the Virtual Showcase can react in various ways to a visitor, enabling intuitive interaction with the displayed content. These interactive Virtual Showcases are an important step in the development of ambient intelligent landscapes, where the computer acts as an intelligent server in the background and visitors can focus on exploring the exhibited content rather than on operating computers.

A Virtual Showcase consists of two main parts (cf. FIG. 4): a convex assembly of half-silvered mirrors 402 and a graphics display 403. So far, we have built Virtual Showcases with two different mirror configurations. Our first prototype 400 consists of four half-silvered mirrors assembled as a truncated pyramid. Our second prototype 401 uses a single mirror sheet to form a truncated cone. In other configurations, the mirrors may be fully silvered; further, other flat to convex assemblies of mirrors may be employed. The mirror assemblies are placed on top of a projection screen 403 which is driven by a system for creating a virtual environment. To a user, real objects, visible inside the mirror assembly through the half-silvered mirrors, merge with graphics that are displayed on the projection screen and reflected by the mirrors. The system for creating the virtual environment creates graphics that are reflected in the portion of the mirrors that is visible from the user's point of view in accordance with the point of view of the user. The portion of the mirrors that are visible from the user's point of view are termed the user's field of view. For our current prototypes, stereo separation and graphics synchronization are achieved with active shutter glasses 406 and infra-red emitters 405, and head-tracking is implemented with an electromagnetic tracking device 407. The cone-shaped prototype 401 provides a seamless surround view of the displayed artifact.

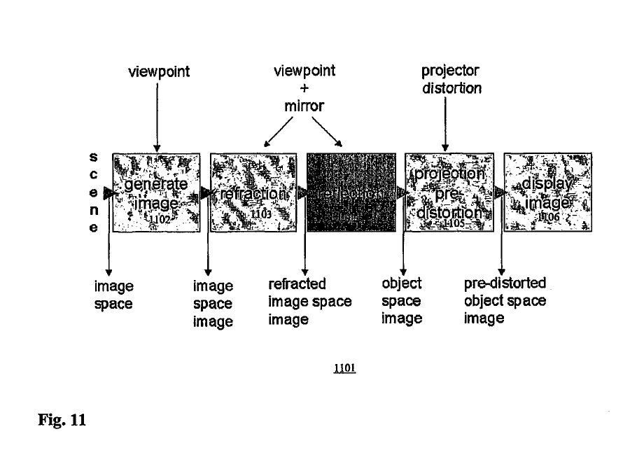

Rendering Techniques for Virtual Showcases: FIG. 11

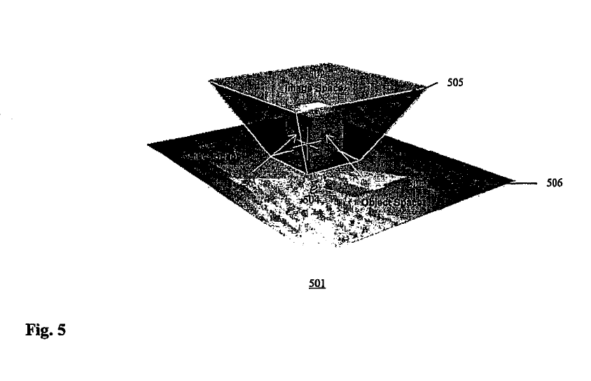

In this section, we describe rendering approaches for each of the Virtual Showcase prototypes. In the following, we refer to the real area in front of a mirror as object space (shown at 503 of FIG. 5), and call the virtual area behind a mirror that is perceived while looking at it the image space (shown at 502). Note, that these definitions follow the conventions of geometric optics rather than those of computer graphics, where the object space is usually the three-dimensional world-coordinate system and the image space is its two-dimensional projection. In geometric optics, however, the object space is the three-dimensional area that contains real light sources (or objects), while the image space is a three-dimensional mapping (e.g. a reflection) of the object space. The manner in which the image space is mapped onto the object space is depends on the geometry of the mirror. While the image space of planar mirrors is an affine map of the object space, the image space of curved mirrors is curvilinearly transformed.

When a virtual reality includes a reflecting surface, the virtual reality system must of course deal with reflections of other objects in the virtual reality in the reflecting surface. What is reflected depends on the point of view from which the virtual reality is being viewed. A number of techniques [15] are used in virtual reality systems to generate reflections on reflecting surfaces in the virtual reality. The techniques include image-based methods [4], geometry-based approaches [7,11,26], and pixel-based techniques [13]. All of the techniques map a given description of a virtual object space (e.g. a computer-generated virtual scene) into a corresponding image space (i.e. a computer-generated reflection of the virtual scene on a virtual artificial mirror surface in the virtual scene).

The most obvious difference between the Virtual Showcase approach and reflections in reflecting surfaces in a virtual reality is that the reflections in the Virtual Showcase are real reflections in real mirrors, instead of simulated reflections in virtual mirrors. However, users do not expect to see a mirror while looking at the Virtual Showcase device. The mirror must rather appear to be transparent—just like a traditional showcase. Reflections on its surface must be seamlessly combinable with any enclosed real objects. In the case of half-silvered mirrors, the image space unites the reflected image of the object space in front of the mirror with the transmitted image of the real environment behind the mirror.

Our aim in rendering the image in the object space is to transform the image space geometry into the object space in such a way that the reflection of the displayed object space optically results in the expected image space. Thus, the transformation of the image space geometry is neutralized by the reflection of the mirror. When the image space includes a real object, a geometric description of the real object can be used to properly cull the virtual portion of the image space with regard to the real object. Because virtual and real objects coexist in conjunction within the image space, the appearance of the entire image space is known for every given viewpoint. The object space must of course be located on a portion of the projection plane where the object space's reflection is in the field of view of the person viewing the miror.

The rendering techniques used in the Virtual Showcase always involve the following steps, shown in overview in FIG. 11:

generating an image of the virtual portion of the contents of image space 502 (step 1102);

transforming the image of the virtual portion so that it is not distorted when reflected in the virtual showcase's mirror (step 1104); and

making the image to be displayed in object space 503 (step 1106).

If the image space also contains a real object with which the virtual portion of the image space must be merged, two further steps may be involved:

correcting for refraction in the mirror (step 1103); and

correcting for distortion in the projector used to display the image in object space 503.

In all of the above steps, the points of view of the person or persons viewing the virtual showcase must be taken into account.

In the following sections we describe rendering techniques that can be applied for Virtual Showcases built from planar mirror-sections and for Virtual Showcases build from a single curved mirror-piece. We assume that a single planar display device (e.g. a rear-projection system) is used, and that the display device and the mirror optics are defined within the same world-coordinate-system. In the upcoming examples, the projection plane matches the x/y-plane of the word-coordinate-system. The pseudo-code for the following methods employs the syntax and functions defined in the OpenGL programming language [24].

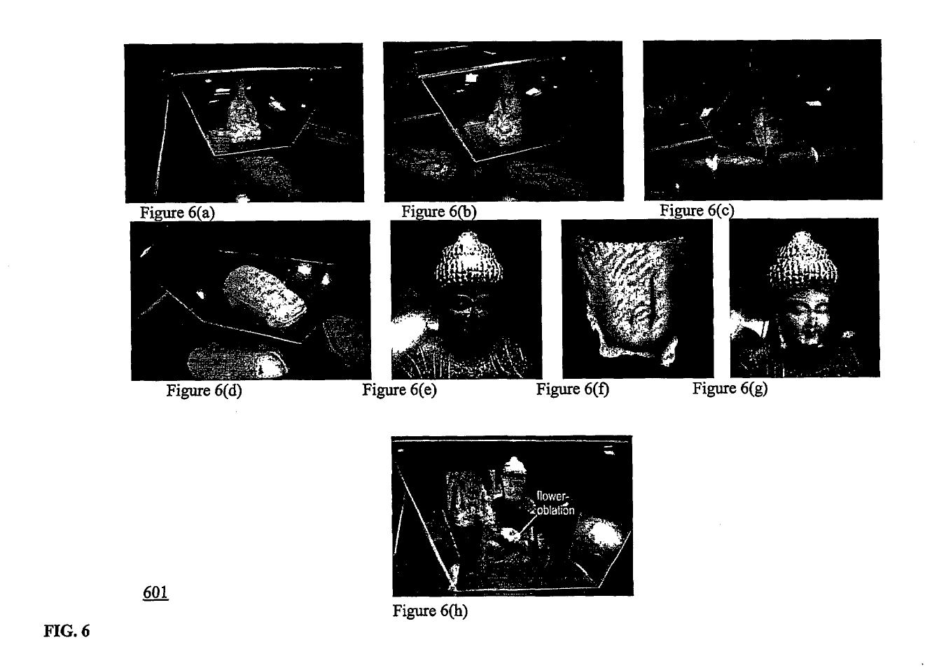

Virtual Showcases Built From Planar Sections: FIGS. 5 and 6

To transform the known image space 502 geometry appropriately into the object space 503, we can apply different, slightly modified transformation pipelines for each planar mirror section. With known plane parameters (\vec{n}ᵣ=[aᵣ,bᵣ,cᵣ],δᵣ) for each mirror, the step of transforming the image of the virtual portion so that it is not distorted when reflected in the virtual showcase's mirror requires two modifications in the model view transformation commonly used to generate a virtual reality based on the model:

1. An additional model transformation is applied between scene transformation M (i.e. the accumulation of glTranslate, glRotate, glScale, etc.) and viewpoint transformation V′ (e.g. gluLookAt). This is realized by multiplying the reflection matrix R with the current transformation matrix—before viewpoint transformation and after scene transformation.

2. The common viewpoint transformation matrix V′ is applied with the reflected viewpoint \vec{e}′, instead of the actual viewpoint \vec{e} 504. The reflected viewpoint can be computed by transforming the actual viewpoint over the specific mirror-plane: \vec{e}′=R·\vec{e}.

The reflection matrix is given by:

$$R = [ \begin{matrix}1 - 2 {a}_{r}^{2} & - 2 {a}_{r} {b}_{r} & - 2 {a}_{r} {c}_{r} & - 2 {a}_{r} {δ}_{r} \\ - 2 {a}_{r} {b}_{r} & 1 - 2 {b}_{r}^{2} & - 2 {b}_{r} {c}_{r} & - 2 {b}_{r} {δ}_{r} \\ - 2 {a}_{r} {c}_{r} & - 2 {b}_{r} {c}_{r} & 1 - 2 {c}_{r}^{2} & - 2 {c}_{r} {δ}_{r} \\ 0 & 0 & 0 & 1\end{matrix} ]$$

Note that the inverse of R is equivalent to R, if \vec{n}ᵣ=[aᵣ, bᵣ, cᵣ,] is normalized. The accumulated transformation matrix can then be written as P·V′·R·M, where P denotes the transformation matrix of the applied off-axis perspective projection (e.g. glFrustum).

Since an individual reflection matrix exists for each mirror plane, a modified model-view transformation (with individual R and \vec{e}′) has to be applied for each front-facing mirror, respectively. Thus, for a given viewpoint \vec{e}, the image space geometry is transformed and rendered multiple times (for each front-facing mirror individually). The example in FIG. 5 illustrates this for a truncated-pyramid-like Virtual Showcase 505. Because the application of R also reverses the polygon order (which influences front-face determination, lighting, back-face culling, etc.), the polygon order has to be reversed explicitly between transformation and rendering [2]. Due to the physical alignment of the mirror planes, the images projected into the object space do not intersect or overlap.

Observed from \vec{e} 504, the different images in object space 503 optically merge into a single consistent image space 502 which is produced by reflecting projection plane 506 in the mirrors 205. The image space thus visually equals the image of the untransformed image space geometry. This is demonstrated in FIG. 6c, where the user's point of view includes two mirrors on two sides of the truncated pyramid. The field of view is thus these two sides, and the virtual reality system produces images in the object space such that a single image space 502 is visible in both mirrors. Note that the photographs of FIG. 6 are not embellished. They are taken as seen from the viewer's perspective, but have been rendered in mono. However, the rendering algorithms normally produce stereo images.

FIGS. 6a and 6b show two individual views onto the same image space (seen from different perspectives). For instance, these views can be seen by a single viewer while moving around the Virtual Showcase, or by two individual viewers while looking at different mirrors simultaneously. While FIG. 6a-6d show exclusively virtual exhibits, FIG. 6e-6h show an example of a mixed (real/virtual) exhibit, displayed within a Virtual Showcase. The surface of the real Buddha statue in FIG. 6e has been scanned three-dimensionally. This virtual model has then been partially projected back onto the real statue to demonstrate the precise superimposition of the two environments (cf. FIG. 6e-6g). FIG. 6h illustrates the whole scenario with additional multi-media information.

Note that in terms of generating stereo images, all transformation and rendering steps have to be applied individually for each eye-position of each viewer. This means that for serving four viewers simultaneously, for instance, the transformation pipeline is split into four sub-pipes after a common scene transformation M. Following the application of the mirror-specific reflection transformations R, the sub-pipelines are split again, to generate the different stereo images for each eye. The subsequent eight sub-pipelines use different viewpoint transformations with individually reflected viewpoints \vec{e}′, corresponding to each eye-position \vec{e}.

In other cases, each viewer may see a different scene (i.e. a different image space is presented to each viewer). In this case, an individual M has to be applied within each sub-pipe. A static mirror-viewer assignment is not required—even individual mirror sections can be dynamically assigned to moving viewers. In case multiple viewers look at the same mirror, an average viewpoint can be computed (this will result in slight perspective distortions).

Note that due to the independence among the transformation sub-pipes, parallel rendering techniques (e.g. using multi-pipeline architectures) may be applied. Since R is affine, the modified transformation pipeline does not require access to the image space geometry. Thus, it can be realized completely independently of the application, and can even be implemented in hardware.

Compensation for refraction in the mirror and distortion caused by the projector can be done as described for the extended virtual table.

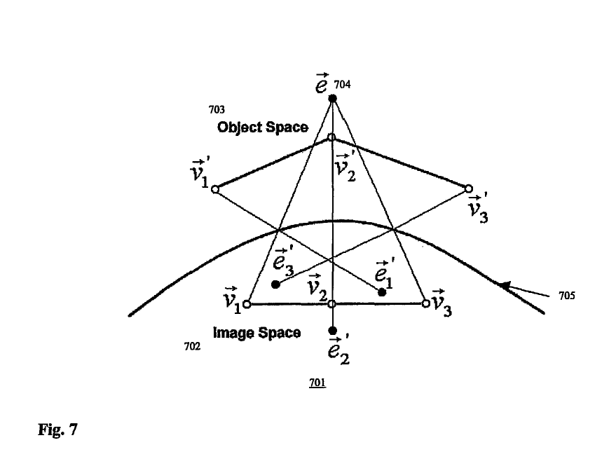

Convex Curved Virtual Showcases: FIGS. 7 and 11

Building Virtual Showcases from one single reflecting sheet, instead of using multiple planar reflecting sections, reduces the calibration problem to a single registration step and consequently decreases the error sources. In addition, the edges of adjacent mirror sections (which can be annoying in some applications) disappear. With a curved virtual showcase, a person's field of view is the portion of the curved surface that the person can see from the person's present point of view.

However, using curved mirrors 705 introduces new problems (with reference to FIG. 7):

1. The transformation of the image space 702 geometry into the object space 703 \vec{v}→\vec{v}′ is not affine but curvilinear.

2. The transformation of the image space geometry depends on the viewpoint 704 (i.e. the image space geometry transforms differently for different viewpoints).

3. The viewpoint transformations \vec{e}→\vec{e}′ depend on the image space geometry (i.e. each vertex \vec{v} within the image space yields an individual \vec{e}′).

To map the image space geometry appropriately into the object space, curved mirrors require per-vertex viewpoint and model transformations. We have developed several non-affine geometry transformation techniques for curved mirrors. However, only highly tessellated image space geometries have an acceptable curvilinear deformation behavior when transformed with these methods.

As modified for curved mirrors, the general technique of FIG. 11 avoids a direct access to the image space geometry, and consequently avoids the transformations of many scene vertices and the cost in time associated with these transformations. The method applies a sequence of intermediate non-affine image deformations. The sequence of deformations is that which we currently consider most efficient for curved mirror displays. The sequence represents a mixture between the extended camera concept [19] and projective textures [32]. While projective textures utilize a perspective texture matrix to map projection-surface vertices into texture coordinates of those pixels that project onto these vertices, our method projects image vertices directly on the projection surface, while the texture coordinate of each image vertex remains constant. This is necessary because curved mirrors yield a different projection (i.e. a different projection origin—or viewpoint) for each pixel. Using individual projection parameters for each pixel, however, is the fundamental idea of the extended camera concept—although originally applied for ray-tracing. In the extended camera concept, the origin of primary rays passing through a pixel of the image plane depends on the pixel location itself. Thus the primary rays are not required to emerge from a single point (perspective projection) or to lie in a plane (orthogonal projection). The modified rays are traced through the scene in the usual way and result in color values for each pixel. The final image presents a projection that has been distorted according to the ray modification function. The main difference from our approach is that the extended camera concept generates a deformed image via ray-tracing, i.e., each pixel is generated from a modified primary ray. Our method deforms an existing image by projecting it individually for each pixel. In the following, the processing required with curved mirrors for the first and second rendering passes 1103 and 1106 will be explained in detail, as well as the processing required to deal with refraction at step 1103 and distortion correction at step 1105.

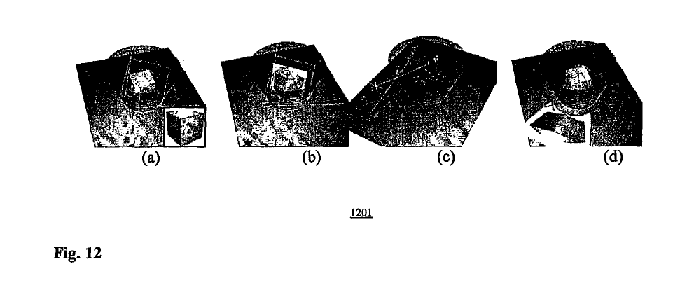

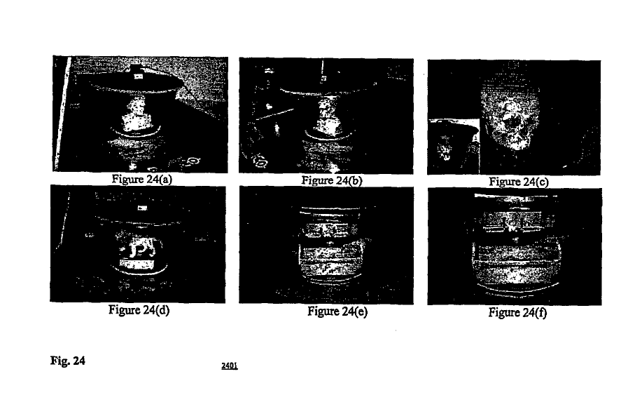

4.2.2.1 Image Generation With Curved Mirrors: FIGS. 12 and 24

The first rendering pass creates a picture of the image space and renders it into the texture buffer, rather than into the frame-buffer (step 1102 of FIG. 11). The processing in this pass is outlined by the generate image algorithm.

generate image:

| | |
|---|---|
| 1: | $compute scene ' s bounding sphere ( position \text{:} \vec{p} ,$ |

radius: θ) with respect to the model transformations M

| | |
|---|---|
| 2: | begin compose GL transformation pipeline (on-axis |

| | perspective projection) from: |
|---|---|
| 3: | $λ = \vert \vec{p} - \vec{e} \vert , δ = \frac{θ \cdot ( λ - θ )}{λ}$ |
| 4: | left = −δ, right = δ, bottom = −δ, |
| | top = δ, near = λ− θ, far = λ+ θ |

| | |
|---|---|
| 5: | set projection transformation p: |

glFrustum(left, right, bottom, top, near, far)

| | |
|---|---|
| 6: | $\begin{matrix}set viewing transformation ( v ) \text{:} \\ gluLookAt ( {\vec{e}}_{x} , {\vec{e}}_{y} , {\vec{e}}_{x} , {\vec{p}}_{x} , {\vec{p}}_{y} , {\vec{p}}_{x} , 0 , 0 , 1 )\end{matrix}$ |
| 7: | set view port transformation: |

glViewPort(0,0,tw,th)

| | |
|---|---|
| 8: | end |
| 9: | apply model transformations M to scene and render |

scene into texture buffer

To generate this image, an on-axis projection is carried out. The size of the projection's viewing frustum is determined from the image space's bounding sphere (lines 1-4). After the transformation pipeline has been set up (lines 5-7), the image is finally rendered into the texture-buffer (line 9). This is illustrated in FIG. 12a for a truncated-cone-like Virtual Showcase.

Note that other rendering methods can be used in the first pass. For example, other techniques (such as image-based and non-photo-realistic rendering, interactive ray-tracing, volume rendering, etc.) can be employed as well as the geometric technique used in generate image. Rendering techniques that generate realistic images of complex scenes at interactive rates are of particular interest for Virtual Showcases. FIG. 24 shows the effects of the use of different renderers. An ordinary geometric renderer was used to generate the images shown in FIG. 24a-24b and 24e-24f; a volumetric renderer [9] was used to generate the image shown at 24c; and a progressive point-based renderer [30] was used for the image displayed in FIG. 24d.

Image Geometry and Reflection Transformation With Curved Mirrors: FIG. 12

The image that has been generated during the first rendering pass has now to be transformed in such as way that its reflection in the mirror is perceived as being undistorted. This is done in step 1104 of FIG. 11. To support the subsequent image deformations, a geometric representation of the image plane is pre-generated. This image geometry consists of a uniformly tessellated grid (represented by an indexed triangle mesh) which is transformed into the current viewing frustum inside the image space in such a way that, if the image is mapped onto the grid each line-of-sight intersects its corresponding pixel (cf. FIG. 12b). Finally, each grid point is transformed with respect to the mirror geometry, the current viewpoint and the projection plane and is textured with the image that was generated during the first rendering pass (cf. FIG. 12c).

While the generate image geometry algorithm describes how the image geometry is transformed into the viewing frustum, the reflection transformation is outlined by the reflect image geometry algorithm. The reflection transformation is described in detail below.

generate image geometry:

| 1: begin create uniform triangle grid with: | |
|---|---|
| 2: | size: s = (−θ,θ),(−θ,θ) (image radius equals radius |
| | of bounding sphere) |
| 3: | position: \vec{q} = \vec{p} (center of grid equals center of |
| | bounding sphere) |
| 4: | orientation: \vec{o} = └2.π−∠([0,−1,0], └\vec{e}ₓ,\vec{e}_{y},0┘), 0,0,1┘∘ |
| | [∠(\vec{e} − \vec{p},[0,0,1]),1,0,0] |
| | (image perpendicular to optical axis) |

5: end

reflect image geometry:

| | |
|---|---|
| 1: | $forall grid vertices of \vec{v}$ |

| | |
|---|---|
| 2: | $\begin{matrix}If front \text{-} facing mirror intersection \vec{i} of \\ \vec{r} = \vec{e} + ( \vec{v} - \vec{e} )\end{matrix}$ |

| | |
|---|---|
| 3: | $compute normal {\vec{n}}_{r} at \vec{i}$ |
| 4: | $compute tangential plane [ {\vec{n}}_{r} , {δ}_{r} ] at \vec{i}$ |
| 5: | $build reflection matrix R from [ {\vec{n}}_{r} , {δ}_{r} ]$ |
| 6: | $\begin{matrix}build projection matrix P from \\ [ {\vec{n}}_{p} = [ 0 , 0 , 1 ] , {δ}_{p} = 0 , \vec{i} ]\end{matrix}$ |
| 7: | $begin pipeline \vec{v} :$ |
| 8: | ${\vec{v}}^{′} = P \cdot R \cdot M \cdot \vec{v}$ |
| 9: | $perspective division \text{:} {\vec{v}}^{′} = \frac{{\vec{v}}^{′}}{w}$ |
| 10: | end |
| 11: | $\vec{v} \text{is} visible$ |

| | |
|---|---|
| 12: | else |

| | |
|---|---|
| 13: | $\vec{v} is not visible$ |

| | |
|---|---|
| 14: | endif |

| | |
|---|---|
| 15: | endfor |

We make sure that only visible triangles (i.e. the ones with three visible vertices) are rendered during the second rendering pass. Therefore, lines 11 and 13 of reflect image geometry set a marker flag for each vertex.

For all grid vertices, the intersection of the geometric line-of-sight (i.e. the ray that is spanned by the eye and the vertex) with the mirror geometry is computed first (line 2). Next, the normal vector at the intersection has to be determined (line 3). The intersection point, together with the normal vector, gives the tangential plane at the intersection. Thus, they deliver the plane parameters for the per-vertex reflection transformation (lines 4-5). Note that an intersection is not given if the viewpoint \vec{e} and the vertex \vec{v} are located on the same side of a tangential plane.

A transformation matrix tat, given a projection origin and plane parameters, projects a 3D vertex onto an arbitrary plane, is generated next (line 6). Note, that in contrast to the projection for planar mirrors, only the beam that projects a single reflected vertex onto the projection plane is of interest. Thus, the generation and application of a perspective projection defined by an entire viewing frustrum in combination with the corresponding view-point transformation (e.g. glFrustum and gluLookAt) would require too much computational overhead and would slow down the image deformation process. In addition, the reflection of the viewpoint becomes superfluous. Since \vec{e}′, the intersection \vec{i} and the final projection \vec{v}′ lie on the same beam, we can use \vec{i} as the origin of the projection, instead of \vec{e}′, making both the matrix multiplication for the view-point transformation and the determination of the viewing frustum unnecessary.

The projection matrix is given by:

$$P = [ \begin{matrix}κ - {a}_{p} x & - {b}_{p} x & - {c}_{p} x & - {δ}_{p} x \\ - {a}_{p} y & k - {b}_{p} y & - {c}_{p} y & - {δ}_{p} y \\ - {a}_{p} z & - {b}_{p} z & k - {c}_{p} z & - {δ}_{p} z \\ - {a}_{p} & - {b}_{p} & - {c}_{p} & - {δ}_{p}\end{matrix} ]$$

where (\vec{n}ₚ=[aₚ,bₚ,cₚ],δₚ) are parameters of the projection plane, [x,y,z,1] are the coordinates of the projection center, and κ=[aₚ,bₚ,cₚ,dₚ[·[x,y,z,1].

Finally, the vertex is sent through the modified transformation pipeline that incorporates the model transformations M, the reflection transformation R, and the projection transformation P (line 8). Since P is a perspective projection, a perspective division has to be done accordingly to produce correct device coordinates (line 9).

Doing this for all image vertices, results in the projected image within the object space (cf. FIG. 12c).

Note that standard graphics pipelines (such as the one implemented within the OpenGL package) only support primitive-based transformations and not per-vertex transformations. Thus, the transformation pipeline used for this approach has been re-implemented explicitly—bypassing the OpenGL pipeline. Note, that in contrast to the transformation of scene geometry, no depth-handling is required for the transformation of the image geometry.

Having a geometric representation to approximate the Virtual Showcase's shape (e.g. a triangle mesh) provides a flexible way of describing the Virtual Showcase's dimensions. However, the computational cost of the per-vertex transformations increases with a higher resolution Virtual Showcase geometry. For triangle meshes, a fast ray-triangle intersection method (such as [23]) that also delivers the barycentric coordinates of the intersection within a triangle is required. The barycentric coordinates can then be used to interpolate between the three vertex normals of a triangle and to approximate the normal vector at the intersection.

A more efficient way of describing the Virtual Showcase's dimensions is to apply an explicit function. This function can be used to calculate the intersections and the normal vectors (using its 1^{st} order derivatives) with an unlimited resolution. However, not all Virtual Showcase shapes can be expressed by explicit functions. Since cones are simple 2^{nd}-order surfaces, we can use an explicit function and its 1^{st}-order derivative to describe the extensions of our curved Virtual Showcase: After a geometric line-of-sight has been transformed from the world-coordinate—into the cone-coordinate-system, it can be easily intersected with the cone by is solving a linear equation system created by inserting a parametric ray representation into the cone equation. The normals are simply computed by inserting the intersection points into the 1^{st} order derivative.

Image Rendering With Curved Mirrors: FIGS. 12,24

During the second rendering pass, shown at 1106 of FIG. 11, the transformed image geometry is finally displayed within the object space—mapping the outcome of the first rendering pass as texture onto the object space's surface (cf. FIG. 12d). Note, that only triangles with three visible vertices are rendered.

Since the reflection transformations of the previous step deliver device coordinates and the projection device as well as the mirror optics have been defined within our world coordinate system, a second projection transformation (e.g. glFrustum) and the corresponding perspective divisions and viewpoint transformation (e.g. gluLookAt) are not required. If a plane projection device is used, a simple scale transformation is sufficient to normalize the device coordinates (e.g. glScale(1/device_width/2),1/device_height/2,1)). A subsequent view-port transformation finally up-scales them into the window coordinate system (e.g. glViewport(0,0,window_width, window_height)).

Time-consuming rendering operations that are not required to display the two-dimensional image (such as illumination computations, back-face culling, depth buffering, etc.) should be disabled to increase the rendering performance. The polygon order does not have to be reversed before rendering.

Obviously, we have a choice between a numerical and an analytical approach to intersecting rays with simple mirror surfaces. Higher order curved mirrors require the application of numerical approximations. In addition, the required grid resolution of the image geometry also depends on the shape of the mirror. Pixels between the triangles of the deformed image mesh are linearly approximated during rasterization (i.e. after the second rendering pass). Thus, some image portions stretch the texture while others compress it. This results in different regional image resolutions. However, our experiments showed that due to the symmetry of our mirror setups, a regular grid resolution and a uniform image resolution achieve acceptable image quality. Since a primitive-based (or fragment-based) antialiasing does not apply in case of a deformed texture, bi-linear or tri-linear texture filters can be utilized instead. Like antialiasing, texture filtering is usually supported by the graphics hardware.

Note that the background of the image and the empty area on the projection plane have to be rendered in black, since black does not emit light and will therefore not be reflected into the image space. FIG. 24a-24f show some results. FIG. 24a-24c show an exclusively virtual exhibit observed from different viewpoints. FIG. 24d-24f illustrate hybrid exhibits (a virtual lion on top of a real base (24d) and a virtual hand that places a virtual cartridge into a real printer (24e,f)).

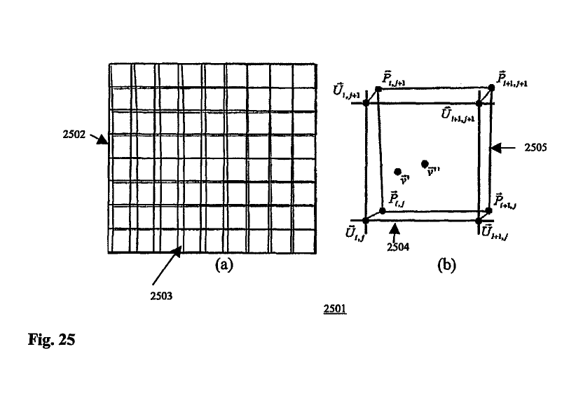

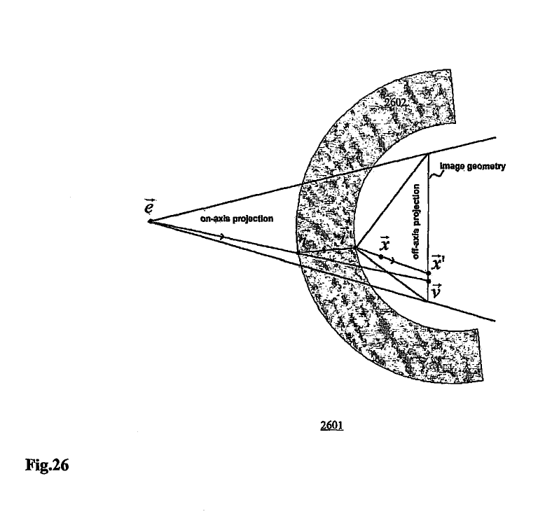

Optical Distortion Compensation With Curved Mirrors: FIGS. 25 and 26

Optical distortion is caused by the elements of an optical system and affects the geometry of a perceived image. The elements that cause optical distortion in case of Virtual Showcases are the projector(s) used to generate the picture within the object space, and the mirror optics that reflect this picture into the image space.

Optical distortion can be critical, since it prevents the precise overlaying of the reflected image of the virtual environment onto the transmitted image of the real environment and can thus lead to inconsistency of the image space.

Note that optical distortion is more complex in our case than it is with fixed-optics devices (head-mounted displays for instance), since the distortion dynamically changes with a moving viewpoint.

We consider and compensate for two sources of optical distortion: miscalibrated projectors and refraction caused by the mirror optics. The compensation techniques developed are smoothly coupled with our two-pass rendering process, completing the rendering pipeline illustrated in FIG. 11. The compensation techniques appear at 1103 and 1105 in that figure.

Miscalibrated Projectors: FIG. 25

If a uniform grid is displayed with a projector whose geometry is miscalibrated, the grid appears deformed and distorted on the projection plane. FIG. 25a shows measures from one of our calibration experiments: While the undistorted black grid 2502 has been sent to the projector, it has been displayed in a deformed way (gray grid 2503), due to the geometry distortion of the projector. The gray grid has been measured by sampling the projected grid points with a precise 2D tracking device.

We can compute a predistortion grid (P) by subtracting the measured distorted grid (D) from the defined undistorted grid (U), and adding the resulting distortion vectors onto U: P=U+(U−D).

As in the approach described in [40], the pre-distort algorithm (step 1105 in FIG. 11) shows how to use P to correct the transformed image vertices \vec{v}′ (after reflect image geometry has been applied). The algorithm differs from [40] in that the image transformation is dynamic, rather than static, and changes with a moving viewpoint.

pre-distort (\vec{v}′):

| | |
|---|---|
| 1: | $begin pre \text{-} distort vertex ( {\vec{v}}^{′} ) \text{:}$ |

| | |
|---|---|
| 2: | $\begin{matrix}find the grid cell that encloses {\vec{v}}^{′} \\ ( {\vec{U}}_{i , j} , {\vec{U}}_{i + 1 , j} , {\vec{U}}_{i , j + 1} , {\vec{U}}_{i + 1 , j + 1} )\end{matrix}$ |
| 3: | $\begin{matrix}compute normalized parameters ( u , v ) of {\vec{v}}^{′} \\ within grid cell \text{:} \\ u = \frac{{\vec{v}}_{x}^{′} - {\vec{U}}_{i , j , x}}{{\vec{U}}_{i + 1 , j , x} - {\vec{U}}_{i , j , x}} , v = \frac{{\vec{v}}_{y}^{′} - {\vec{U}}_{i , j , y}}{{\vec{U}}_{i , j + 1 , y} - {\vec{U}}_{i , j , y}}\end{matrix}$ |
| 4: | $\begin{matrix}compute {\vec{v}}^{″} by linear interpolating between \\ corresponding distorted grid cell points \\ ( {\vec{P}}_{i , j} , {\vec{P}}_{i + 1 , j} , {\vec{P}}_{i , j + 1} , {\vec{P}}_{i + 1 , j + 1} ) \text{:} \\ {\vec{v}}^{″} = {\vec{P}}_{i , j} \cdot ( 1 - u ) \cdot ( 1 - v ) + \\ {\vec{P}}_{i + 1 , j} \cdot u \cdot ( 1 - v ) + {\vec{P}}_{i , j + 1} \cdot ( 1 - u ) \cdot v + \\ {\vec{P}}_{i + 1 , j + 1} \cdot u \cdot v\end{matrix}$ |

| | |
|---|---|
| 5: | end |

The grid cell within U 2504 that encloses \vec{v}′ and the normalized cell coordinates of \vec{v}′ within this cell have to be determined (line 2-3).

Finally, a pre-distorted vertex (\vec{v}″) can be computed by linear interpolating within the corresponding grid cell of P 2505, using the normalized cell coordinates (line 4). This is illustrated in FIG. 25b.

Displaying the transformed image vertex at its pre-distorted position lets it appear at its correct location on the projection plane, since the pre-distortion is neutralized by the projector's geometry distortion.

Note that the pre-distortion simply represents an additional image transformation. The projector pre-distortion transformation is applied after the reflection transformation (reflect image geometry) and before the second rendering pass is carried out. This transformation is optional and can be switched off to save rendering time—even though it does not slow down rendering performance significantly.

In-Out Refractions: FIG. 26

Light rays that travel through materials with different densities 2602 are refracted. Therefore, the transmitted image of the real environment inside the Virtual Showcase is also refracted. However, the image within the object space (i.e. the projected graphics of the virtual environment) that is reflected by the Virtual Showcase's front-surface mirror is not refracted. Consequently, both images do not overlay exactly, even if the spatial registration of both environments is precise. As it is the case with projector miscalibration, refraction distortion is dynamic and changes with a moving viewpoint (i.e. compensation methods for static optical distortion, such as [39,40] cannot be applied).

Since physics prevent us from pre-distorting refraction within the real environment, we artificially refract the image of the virtual environment instead to make both images match.

The react algorithm (step 1103 in FIG. 11) demonstrates how to apply refraction to the image that has been generated during the first rendering pass. Note that the image is refracted before the reflection transformation (reflect image geometry) is applied to the image geometry. As in the other image transformation steps, per-vertex computations are caried out explicitly since this transformation is not supported by standard rendering pipelines.

refract (\vec{v}):

| | |
|---|---|
| 1: | $\begin{matrix}compute intersection ( \vec{i} ) of geometric line \text{-} of \text{-} sight \\ \vec{r} = \vec{e} + ( \vec{v} - \vec{e} ) with outer mirror surface , and determine \\ corresponding normal ( \vec{n} ) at \vec{i}\end{matrix}$ |
| 2: | $\begin{matrix}compute in \text{-} refracted ray ( {\vec{r}}^{′} ) from \vec{r} at \vec{i} using Snell ' s \\ law of refraction\end{matrix}$ |
| 3: | $\begin{matrix}compute intersection ( {\vec{i}}^{′} ) of {\vec{r}}^{′} with inner mirror surface , \\ and determine corresponding normal ( {\vec{n}}^{′} ) at {\vec{i}}^{′}\end{matrix}$ |
| 4: | $\begin{matrix}compute out \text{-} refracted ray ( {\vec{r}}^{″} ) from {\vec{r} }^{′} at {\vec{i} }^{′} using \\ Snell ' s law of refraction\end{matrix}$ |
| 5: | $\begin{matrix}transform {\vec{i}}^{′} and any point ( \vec{x} ) on {\vec{r}}^{″} into the coordinate \\ system of the image geometry\end{matrix}$ |
| 5: | begin set texture matrix (x), off-axis perspective |
| | projection: |

| | |
|---|---|
| 6: | set normalization correction: |
| | Scale(0.5,0.5,0.5), Translate(1,1,0) |

| | |
|---|---|
| 7: | $\begin{matrix}set projection transformation \text{:} \\ φ = \frac{( {\vec{i}}_{x}^{′} - 1 )}{{\vec{i}}_{x}^{′}} , left = - φ \cdot ( 1 + {\vec{i}}_{x}^{′} ) , right = φ \cdot ( 1 - {\vec{i}}_{x}^{′} ) \\ bottom = - φ \cdot ( 1 + {\vec{i}}_{y}^{′} ) , top = φ \cdot ( 1 - {\vec{i}}_{y}^{′} ) , \\ near = {\vec{i}}_{x}^{′} - 1 , far = {\vec{i}}_{x}^{′} + 1\end{matrix}$ |

| | Frustum(left,right,bottom,top,near,far) |
|---|---|
| 8: | $\begin{matrix}set viewing transformation with translated \\ viewpoint \text{:} \\ LookAt ( {\vec{i}}_{x}^{′} , {\vec{i}}_{y}^{′} , {\vec{i}}_{x}^{′} , {\vec{i}}_{x}^{′} , {\vec{i}}_{y}^{′} , 0 , 0 , 1 , 0 )\end{matrix}$ |

| | |
|---|---|
| 9: | end |
| 10: | $\begin{matrix}compute new texture coordinate ( {\vec{x}}^{′} ) for the particular \\ image vertex ( \vec{v} ) : {\vec{x}}^{′} = X \cdot \vec{x}\end{matrix}$ |

For each image vertex, the according geometric line-of-sight is computed. Using Snell's law of refraction, the corresponding optical line-of-sight can be determined by computing the in/out refractors at the associated surface intersections (lines 14). Note that the derivation of the optical lines-of-sight for planar mirrors is less complex, since in this case the optical lines-of-sight equal the parallel shifted geometric counterparts.

We can now determine the refraction of the image vertex (\vec{v}) by computing the geometric intersection of the out-refractors with the image geometry.

To simulate refraction, however, we only need to ensure that the pixel at \vec{x}′ will be seen at the location of \vec{v}. Instead of generating a new image vertex at \vec{x}′ and transforming it to the location of \vec{v}, we can also assign the texture coordinate at \vec{x}′ to the existing vertex \vec{v}.

In this case, we can keep the number of image vertices (and consequently the time required for the reflection transformation) constant.

The intersection of the in-refractor with the outer mirror surface (\vec{i}′) and an arbitrary point on the out-refractor (\vec{x}) are transformed into the coordinate system of the image geometry, next (line 5).

The composition of an appropriate texture matrix that computes new texture coordinates for each image vertex is outlined in lines 5-9. As illustrated in FIG. 26, an off-axis projection transformation is applied, where the center of projection is \vec{i}′. By multiplying \vec{x} by the resulting texture matrix projects \vec{x} to the correct location within the normalized texture space of the image (line 10). Finally, the resulting texture coordinate (\vec{x}′) has to be assigned to \vec{v}.

Nevertheless, our refraction method faces the following problems for outer areas on the image:

Given a geometric line-of-sight to an outer image vertex, its corresponding optical line-of-sight does not intersect the image. Thus, an image vertex exists but its new texture coordinate cannot be computed. This results in vertices with no, or wrong texture information.

Given an optical line-of-sight to an outer pixel on the image, its corresponding geometric line-of-sight does not intersect the image. Thus, a texture coordinate can be found but an assignable image vertex does not exist. Consequently, the portion surrounding this pixel cannot be transformed. This results in image portions that aren't mapped onto the image geometry.

A simple solution for these problems is to ensure that they do not occur for image portions which contain information: The image size depends on the radius of the scene's bounding sphere. We can simply increase the image by adding some constant amount to the bounding sphere's radius before carrying out the first rendering. An enlarged image does not affect the image content, but simply subjoins additional outer image space to the image. The subjoined space does not contain any information (i. e., it is just black pixels). In this way, we ensure that the problems occur only in the subjoined new (black) regions. Because these regions are black, they will not be visible as reflections in the mirror.

Note that the refraction computations represent another transformation of the image generated during the first rendering pass. In contrast to the reflection transformations (reflect image geometry) and the projector pre-distortion transformation (pre-distort), which transform image vertices, the refraction transformation transforms texture coordinates. However, all image transformations have to be applied before the final image is displayed during the second rendering pass.

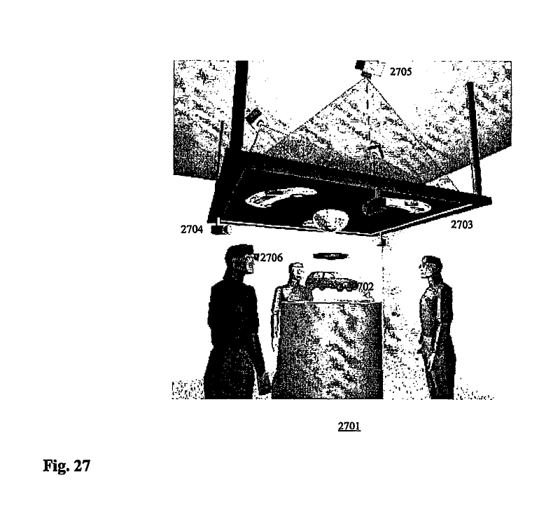

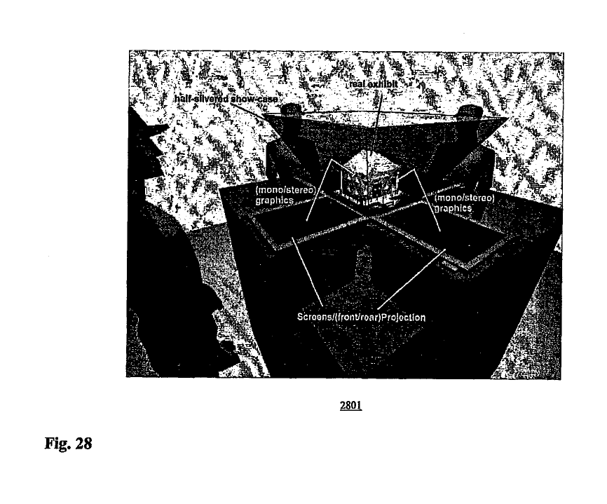

4.3 Other Virtual Showcase Configurations, FIGS. 27 and 28

Experience with the existing prototypes has led to a number of refinements to the Virtual Showcase. Shown in FIG. 27 is an upside-down configuration of mirror optics 2702 and projection display 2703. This important improvement eliminates disturbing reflections on the inside of the mirror optics and hides the projection display from the observer. In system 2701, optical tracking technology 2704 will be utilized instead of electromagnetic tracking technology, making head-tracking more precise and stable and eliminating impeding cables. System 2701 will also use passive stereo projection 2705 (with multiple polarized projectors), instead of a single time-multiplexed projector, allowing the observers to wear light-weight and inexpensive polarized glasses 2706. In addition, the cost of the projection technology can be reduced.

In another configuration we propose to apply single screens 2802 for each of the mirrors respectively (cf. FIG. 28). These screens can be, for instance, CRT screens or auto-stereoscopic displays. Networked off-the-shelf personal computers will drive rendering, tracking and interaction tasks, reducing the setup's overall cost and making it easily upgradeable.

5. Conclusion

The foregoing Detailed Description has disclosed to those skilled in the arts to which the invention pertains how to make and use virtual showcases and has also disclosed the best mode presently known to the inventors of making virtual showcases. It will be immediately apparent to those skilled in the relevant arts that configurations of virtual showcases other than those disclosed herein are possible, that different techniques may be used to track the motion of the user's head, and that the object space may be generated by techniques other than those disclosed herein, and that the object space may be computed from the image space by techniques other than those disclosed herein. There may thus be many implementations of virtual showcases which are implemented using the principles embodied in the virtual showcases disclosed herein but which differ in other respects from the disclosed virtual showcases. That being the case, the Detailed Description is to be regarded as being in all respects exemplary and not restrictive, and the breadth of the invention disclosed herein is to be determined not from the Detailed Description, but rather from the claims as interpreted with the full breadth permitted by the patent laws.

6. References for the Discussion of the Virtual Showcase

[1] Bimber, O., Encarnacao, L. M., and Schmalstieg, D. Real Mirrors Reflecting Virtual Worlds. In Proceedings of IEEE Virtual Reality (VR'00), IEEE Computer Society, pp. 21-28,2000.

[2] Bimber, O., Encarnacao, L. M., and Schmalstieg, D. Augmented Reality with Back-Projection Systems using Transflective Surfaces. Computer Graphics Forum (Proceedings of EUROGRAPFICS 2000), vol. 19, no. 3, NCC Blackwell, pp. 161-168, 2000.

[3] Bimber, O., Frohlich, B., Schmalstieg, D, and Encarnacao, L. M. Distinctions between Virtual Showcases and related Mirror Displays/Optical Distortion Compensation for Virtual Showcases. URL: http://docserver.fhg.de/igd/2001/-bimber/001.pdf, 2001.

[4] Blinn, J. F. and Newell, M. E. Texture and reflection in computer generated images. Communications of the ACM, vol. 19, ACM Press, pp. 542-546, 1976.

[5] Breen, D. E., Whitaker, R. T., Rose, E., and Tuceryan, M. Interactive Occlusion and Automatic Object Placement for Augmented Reality. Computer Graphics Forum (Proceedings of EUROGRAPHICS'96), vol. 15, no. 3, NCC Blackwell, pp. C11-C22, 1996.

[6] Chinnock, C. Holographic 3-D images float in free space. Laser Focus World, vol. 31, no. 6, pp. 22-24, 1995.

[7] Diefenbach, P. J. and Badler, N. I. Multi-pass pipeline rendering: realism for dynamic environments. In Proceedings of Symposium on Interactive 3D Graphics '97, ACM Press, 1997.

[8] Dimensional Media Associates, Inc., URL: http://www.3dmedia.com/, 2000.

[9] Eckel, G. OpenGL Volumizer Programmer's Guide. Silicon Graphics Inc., URL:

http://www.sgi.com/software/volumizer/tech_info.html, 1998.

[10] Elings, V. B. and Landry, C. J. Optical display device. U.S. Pat. No. 3,647,284, 1972.

[11] Foley, J. D., Van Dam, A., Feiner, S., and Hughes, J. F. Computer Graphics: Principles and Practice, 2^{nd} ed., Addison-Wesley, 1990.

[12] Fuchs, H., Pizer, S. M., Tsai, L. C., and Bloombreg, S. H. Adding a True 3-D Display to a Raster Graphics System. IEEE Computer Graphics and Applications, vol. 2, no. 7, pp. 73-78, IEEE Computer Society, 1982.

[13] Glassner, A. S. An Introduction to ray-tracing. Academic Press, August 1989.

[14] Gortler, S. J., Grzeszczuk, R., Szeliski R,. and Cohen, M. P. The Lumigraph. Computer Graphics (Proceedings of SIGGRAPH'96), pp. 43-54, 1996.

[15] Heidrich, W. Interactive Display of Global Ilumination Solutions for Non-Diffuse Environments. State of The Art Report EUROGRAPHICS'00, pp. 1-19, 2000.

[16] Hoppe, H. View-Dependent Refinement of Progressive Meshes. Computer Graphics (Proceedings of SIGGRAPH'97), pp. 189-198, ACM Press, 1992.

[17] Knowlton, K. C. Computer Displays Optically Superimpose on Input Devices. Bell Systems Technical Journal, vol. 53, no. 3, pp. 36-383, 1977.

[18] Levoy, M. and Hanraham, P. Light field rendering. Computer Graphics (Proceedings of SIGGRAPH'96), pp. 31-42, ACM Press, 1996.

[19] Loffelmann, H., Gröller, E. Ray Tracing with Extended Cameras. Journal of Visualization and Computer Animation, vol. 7, no. 4, pp. 211-228, Wiley (publ.), 1996.

[20] McKay, S., Mason, S., Mair, L. S., Waddell, P., and Fraser, M. Membrane Mirror Based Display For Viewing 2D and 3D Images. In proceedings of SPIE, vol. 3634, pp. 144-155, 1999.

[21] McKay, S., Mason, S., Mair, L. S., Waddell, P., and Fraser, M. Stereoscopic Display using a 1.2-M Diameter Stretchable Membrane Mirror. In proceedings of SPIE, vol. 3639, pp. 122-131, 1999.

[22] Mizuno, G. Display device. U.S. Pat. No. 4,776,118, 1988.

[23] Möller, T., and Trumbore, B. Fast, Minimum Storage Ray-Triangle Intersection. Journal of Graphics Tools. vol. 2, no. 1, pp. 21-28, 1997.

[24] Neider, J., Davis, T., and Woo, M. OpenGL programming Guide. Addison-Wesley Publ., ISBN 0-201-63274-8, 1993.

[25] Nvidia, Corp. GeForce 3. URL: http://www.nvidia.com, 2001.

[26] Ofek, E. and Rappoport A. Interactive reflections on curved objects. Computer Graphics (Proceedings of SIGGRAPH'98), pp. 333-342, ACM Press, 1998.

[27] Poston, T. and Serra, L. The Virtual Workbench: Dextrous VR. In Proceedings of Virtual Reality Software and Technology (VRST'94), pp. 111-121, IEEE Computer Society (publ.), 1994.

[28] Raskar, R, Welch, G., and Fuchs, H. Spatially Augmented Reality. In Proceedings of First IEEE Workshop on Augmented Reality (IWAR'98). San Francisco, Calif., A.K. Peters Ltd. (publ.), 1998.

[29] Raskar, R., Welch, G., and Chen, W-C. Table-Top Spatially Augmented Reality: Bringing Physical Models to Life with Projected Imagery. In Proceedings of Second International IEEE Workshop on Augmented Reality (IWAR'99). San Francisco, Calif., A.K. Peters Ltd. (publ.), 1999.

[30] Rusinliewicz, S. and Levoy, M. QSplat: A Multiresolution Point Rendering System for Large Meshes. Computer Graphics (Proceedings of SIGGRAPH'00), pp. 343-352, ACM Press, 2000.

[31] Schmandt, C. Spatial Input/Display Correspondence in a Stereoscopic Computer Graphics Workstation. Computer Graphics (Proceedings of SIGGRAPH'83), vol. 17, no. 3, pp. 253-261, ACM Press, 1983.

[32] Segal, M., Korobkin, C., van Widenfelt, R., Foran, J., and Haeberli, P. E. Fast Shadows and Lighting Effects Using Texture Mapping, Computer Graphics (Proceedings of SIGGRAPH'92), pp. 249-252, ACM Press, 1992.

[33] Starkey, D. and Morant, R. B. A technique for making realistic three-dimensional images of objects. Behaviour Research Methods & Instrumentation, vol. 15, no. 4, pp. 420-423, The Psychonomic Society, 1983.

[34] Summer S. K., et. al. Device for the creation of three-dimensional images. U.S. Pat. No. 5,311,357, 1994.

[35] Villasenor, J. and Mangione-Smith, W. H. Configurable Computing. ‘Scientific America, pp. 54-59, Scientific America publ.), 1997.

[36] Walker, M. Ghostmasters: A Look Back at America's Midnight Spook Shows. Cool Hand Publ., ISBN 1-56790-146-8, 1994.

[37] Weigand, T. E., von Schloerb, D. W., and Sachtler, W. L. Virtual Workbench: Near-Field Virtual Environment System with Applications. Presence, vol. 8, no. 5, pp. 492-519,MITPress, 1999.

[38] Welck, S. A. Real image projection system with two curved reflectors of paraboloid of revolution shape having each vertex coincident with the focal point of the other. U.S. Pat. No. 4,2502,750, 1989.

[39] Rolland, J. P. and Hopkins, T. A Method of Computational Correction for Optical Distortion in Head-Mounted Displays. Technical Report, Department of Computer Science, UNC Chapel Hill, no. TR93-045, 1993.

[40] Watson, B. and Hodges, L. Using Texture Maps to Correct for Optical Distortion in Head-Mounted Displays. In Proceedings of IEEE VRAIS'95, IEEE Computer Society, 1995.

What is claimed is:

1. Apparatus for producing an image space comprising:
apparatus for producing an object space;
a convex reflective surface having a position relative to the object space such that there is a reflection of the object space in the reflective surface; and
a tracker that tracks the position of the head of a person who is looking into the convex reflective surface,
the apparatus for producing the object space receiving the position information from the tracker, using the position information to determine the person's field of view in the reflective surface, and producing the object space such that the image space appears in the field of view.

2. The apparatus for producing an image space set forth in claim 1 wherein:
the image space does not appear to the person to be distorted.

3. The apparatus for producing an image space set forth in claim 1 wherein:
the reflective surface comprises a plurality of planar reflective surfaces.

4. The apparatus for producing an image space set forth in claim 3 wherein:
when the field of view includes more than one of the planar reflective surfaces, the apparatus for producing the object space produces the object space such that the reflections of the object space in all of the planar reflective surfaces included in the field of view contain the same image space.

5. The apparatus for producing an image space set forth in claim 3 wherein:
the apparatus for producing the object space produces a separate image space in each of the plurality of planar reflective surfaces.

6. The apparatus for producing an image space set forth in claim 5 wherein:
the apparatus for producing the object space produces the separate image space in a given one of the plurality of planar reflective surfaces whenever the field of view includes the given planar reflective surface.

7. The apparatus for producing an image space set forth in claim 6 wherein:
there is a plurality of fields of view.

8. The apparatus for producing an image space set forth in claim 3 wherein:
there is a plurality of the object spaces; and
individual ones of the planar reflective surfaces reflect separate ones of the object spaces

9. The apparatus for producing an image space set forth in claim 3 wherein:
the plurality of planar reflective surfaces are sides of a pyramid.

10. The apparatus for producing an image space set forth in claim 9 wherein:
the pyramid is truncated.

11. The apparatus for producing an image space set forth in claim 9 wherein:
the plurality of planar reflective surfaces includes all of the sides of the truncated pyramid.

12. The apparatus for producing an image space set forth in claim 11 wherein:
the truncated pyramid has four sides.

13. The apparatus for producing an image space set forth in claim 1 wherein:
the reflective surface is curved.

14. The apparatus for producing an image space set forth in claim 1 wherein:
the curved surface is a conical surface.

15. The apparatus for producing an image space set forth in claim 14 wherein:
the conical surface is closed.

16. The apparatus for producing an image space set forth in claim 15 wherein:
the conical surface is truncated.

17. The apparatus for producing an image space set forth in any one of claims 1 through 16 wherein:
the object space is above the reflective surface.

18. The apparatus for producing an image space set forth in any one of claims 1 through #All wherein:
the object space is below the reflective surface.

19. The apparatus for producing an image space set forth in any one of claims 1 through 16 wherein:
the apparatus for producing the object space produces the object space on a projection plane.

20. The apparatus for producing an image space set forth in any one of claims 1 through 16 wherein:
the apparatus for producing the object space employs active stereo projection.

21. The apparatus for producing an image space set forth in any one of claims 1 through 16 wherein:
the apparatus for producing the object space employs passive stereo projection.

22. The apparatus for producing an image space set forth in any one of claims 1 through 16 wherein:
the tracker is an electromagnetic tracker.

23. The apparatus for producing an image space set forth in any one of claims 1 through 16 wherein:
the tracker is an optical tracker.

24. The apparatus for producing an image space set forth in any one of claims 1 through 16 wherein:
there is an object behind the reflective surface relative to the person; and
the reflective surface has the property that when the object is illuminated, the object becomes visible to the person through the reflective surface.

25. The apparatus for producing an image space set forth in claim 24 wherein:
the object belongs to the image space and the reflection of the object space augments the object.

26. The apparatus for producing an image space set forth in any one of claims 1 through 16 wherein:
the object space is produced in a plurality of separate display devices.

27. The apparatus for producing an image space set forth in claim 26 wherein:
the apparatus for producing the object space includes a network of processors.

28. The apparatus for producing an image space set forth in any one of claims 1 through 16 wherein:
the reflective surface is in a position analogous to that of a transparent surface in a conventional showcase.

29. A method of producing an object space such that the object space's reflection in a reflecting surface when the reflecting surface contains an image space as viewed from a specific point of view,
the method comprising the steps of:
generating the image space;
determining how the image space must be modified to produce an object space which, when produced on the projection plane, will result in a reflection in the reflecting surface that contains the image space; and
producing the object space.

30. The method set forth in claim 29 further comprising the step performed after the step of determining of:
further modifying the image space to compensate for geometry distortion that occurs when the object space is produced on the projection plane.

31. The method set forth in either claim 29 or claim 30 wherein:
the reflecting surface has the property that when an object behind the reflecting surface relative to the specific point of view is illuminated, the object is visible through the reflecting surface;
the object belongs to the image space; and
the method further comprises the step of:
further modifying the image space to compensate for refraction of light from the illuminated object by the reflecting surface.

32. Apparatus for producing an image space comprising:
apparatus for producing an object space;
a reflective surface that has a position relative to the object space such that there is a reflection of the object space in the reflective surface; and
a tracker that tracks the position of the head of a person who is looking into the reflective surface,
the apparatus for producing the object space receiving position information from the tracker, using the position information to determine a point of view, and producing the object space such that the reflection contains the image space as seen from the point of view.

33. A method of transforming an image space to produce a planar object space such that when a reflection of the object space in a curved reflective surface is seen from a given point of view, the reflection contains the image space,
the method comprising the steps of:
making a geometric representation of the image space that includes vertices of the image space and in which each line of sight from the given point of view into the image space intersects its vertex in the geometric representation; and
for each ray that spans the given point of view and a vertex,
determining an intersection of the ray with a curved surface whose geometry is that of the reflective surface and a reflection of the ray from the curved surface at the intersection; and
making a projection of the ray's reflection onto the object space's plane.

34. The method set forth in claim 33 wherein
the planar object space is produced by a projector with distortion; and
the method farther includes the step of:
for each ray that is distorted by the projector, modifying the projection of the ray's reflection onto the object space's plane to counteract the ray's distortion.

35. The method set forth in either claim 33 or claim 34 wherein
the image space includes an object that is seen through the reflecting surface;
light that passes through the reflecting surface is refracted; and
the method further includes the step of:
for each ray, modifying the intersection of the ray with the curved surface to take refraction by the reflecting surface into account.
